(19) United States
(12) Patent Application Publication
(10) Pub. No.: US 2021/0014103 A1
(43) Pub. Date: Jan. 14, 2021

(54) METHOD AND APPARATUS FOR LOCATING ROOT CAUSE ALARM, AND COMPUTER-READABLE STORAGE MEDIUM

(71) Applicant: HUAWEI TECHNOLOGIES CO., LTD., Shenzhen (CN)

(72) Inventors: Keli ZHANG, Shenzhen (CN); Caifeng HE, Shenzhen (CN); Kalander MARCUS, Hong Kong (CN); Yijun LIU, Shenzhen (CN); Ivy PENG, Shenzhen (CN); Yahui LI, Shenzhen (US)

(21) Appl. No.: 17/035,054

(22) Filed: Sep. 28, 2020

Related U.S. Application Data
(63) Continuation of application No. PCT/CN2019/071583, filed on Jan. 14, 2019.

(30) Foreign Application Priority Data
Mar. 29, 2018 (CN) 201810268926.7

(51) Int. Cl. H04L 12/24

(52) U.S. Cl. CPC H04L 41/0631

(57) ABSTRACT

Example methods and apparatus for locating a root cause alarm are described. One example method includes obtaining an alarm correlation rule of a telecommunications network. The alarm correlation rule is split to obtain candidate root cause rules. Time sequence information of the candidate root cause rules are determined based on historical alarm data of the telecommunications network.

### CROSS-REFERENCE TO RELATED APPLICATIONS

This application is a continuation of International Application No. PCT/CN2019/071583, filed on Jan. 14, 2019, which claims priority to Chinese Patent Application No. 201810268926.7, filed on Mar. 29, 2018. The disclosures of the aforementioned applications are hereby incorporated by reference in their entireties.

### TECHNICAL FIELD

The present application relates to the fault alarm field of the telecommunications network, and more specifically, to a method and an apparatus for locating a root cause alarm, and a computer-readable storage medium.

### BACKGROUND

As a telecommunications network continuously expands, there are increasingly more types and quantities of alarms generated on the telecommunications network. To ensure normal running of the telecommunications network, root cause alarms need to be located in time from a plurality of alarms generated on the telecommunications network, to clear these root cause alarms as soon as possible.

In a conventional solution, technical experts analyze alarm data of the telecommunications network based on experience of the technical experts, summarize causal relationships between different alarms and priorities of the different alarms, construct a root cause decision network based on the causal relationships between the different alarms and the priorities of the different alarms, and finally locate a root cause alarm in an alarm stream based on the root cause decision network.

When there are many types of alarms, the root cause decision network cannot be accurately constructed based on the experience or knowledge of the technical experts in the conventional solution. Consequently, a root cause alarm cannot be relatively accurately located in the conventional solution.

### SUMMARY

This application provides a method and an apparatus for locating a root cause alarm, and a computer-readable storage medium, so as to improve accuracy of locating a root cause alarm.

According to a first aspect, a method for locating a root cause alarm on a telecommunications network is provided. The method includes: obtaining an alarm correlation rule of the telecommunications network; splitting the alarm correlation rule to obtain candidate root cause rules; determining time sequence information of the candidate root cause rules based on historical alarm data of the telecommunications network; determining valid root cause rules in the candidate root cause rules based on the time sequence information of the candidate root cause rules; extracting an associated alarm combination from an alarm stream of the telecommunications network; and determining a root cause alarm in the associated alarm combination based on the valid root cause rules.

The candidate root cause rules each include a first alarm and a second alarm. The time sequence information of the candidate root cause rules is used to indicate a probability that the first alarm occurs before the second alarm in terms of time.

The historical alarm data may include alarm data of many telecommunications devices on the telecommunications network. The historical alarm data may include an alarm category, a time when an alarm occurs, a device on which an alarm occurs, and the like.

Optionally, the splitting the alarm correlation rule to obtain candidate root cause rules includes: splitting the alarm correlation rule to obtain a plurality of alarms; and combining the plurality of alarms in pairs to obtain the candidate root cause rules.

A candidate root cause rule that includes two alarms may be obtained by combining the plurality of alarms in the alarm root cause rule in pairs, so as to analyze a causal relationship between any two alarms in the alarm correlation rule.

It should be understood that there may be a plurality of candidate root cause rules. Each candidate root cause rule includes two alarms. Specifically, each candidate root cause rule includes a first alarm and a second alarm. In addition, the first alarm may be an alarm that is in the front of the candidate root cause rule (or may be referred to as a first-order alarm or a pre-order alarm). The second alarm may be an alarm that is in the back of the candidate root cause rule (or may be referred to as a post-order alarm).

In this application, the valid root cause rules may be selected from the candidate root cause rules based on a probability that an alarm in each of the candidate root cause rules occurs before another alarm in terms of time (in other words, the valid root cause rules may be selected from the candidate root cause rules based on the time sequence information). Therefore, the root cause alarm can be more accurately located based on the valid root cause rules.

Optionally, the obtaining an alarm correlation rule of the telecommunications network includes: determining the alarm correlation rule of the telecommunications network based on the historical alarm data of the telecommunications network.

Specifically, the alarm correlation rule of the telecommunications network may be determined or generated by performing frequent item mining on the historical alarm data of the telecommunications network.

It should be understood that frequent item mining is a most basic method in the data mining field, is used to find data items or modes that frequently occur as a combination and that are in a large quantity of data, and is a most commonly used method for mining an association relationship between data.

The valid root cause rules may be root cause rules whose time sequence information meets a preset requirement.

In a possible implementation, the time sequence information is a time sequence coefficient, and the time sequence coefficient is used to indicate a probability that the first alarm in the candidate root cause rule occurs before the second alarm in terms of time.

Optionally, a larger time sequence coefficient indicates a higher probability that the first alarm in the candidate root cause rule occurs before the second alarm in terms of time.

In a possible implementation, when the time sequence information is a time sequence coefficient, the determining valid root cause rules in the candidate root cause rules based on the time sequence information of the candidate root cause rules includes: determining, in the candidate root cause rules, root cause rules whose time sequence coefficients are within a preset range as the valid root cause rules.

Root cause rules (in other words, the valid root cause rules) whose validity meets a requirement may be selected from the candidate root cause rules based on the time sequence coefficient, so as to subsequently locate the root cause alarm based on these root cause rules with higher validity.

Optionally, the determining, in the candidate root cause rules, root cause rules whose time sequence coefficients are within a preset range as the valid root cause rules includes: determining, in the candidate root cause rules, root cause rules whose time sequence coefficients are greater than or equal to a first time sequence coefficient threshold as the valid root cause rules.

Optionally, a value range of the time sequence coefficients is [0, 1]. When the time sequence coefficient is 0, it indicates that the first alarm in the candidate root cause rule certainly does not occur before the second alarm. When the time sequence coefficient is 1, it indicates that the first alarm in the candidate root cause rule certainly occurs before the second alarm.

The first time sequence coefficient threshold may be 0.5. To be specific, when a time sequence coefficient of a specific candidate root cause rule is greater than or equal to 0.5, the candidate root cause rule is a valid root cause rule.

In a possible implementation, the determining time sequence information of the candidate root cause rules based on historical alarm data of the telecommunications network includes: determining, based on the historical alarm data, a quantity of times that the first alarm occurs before or after the second alarm at a preset time interval; and determining the time sequence information of the candidate root cause rules based on the quantity of times that the first alarm occurs before or after the second alarm at the preset time interval.

The historical alarm data may be analyzed to learn of quantities of times that the first alarm and the second alarm occur at a past specific time interval and an occurrence sequence, so that a probability that the first alarm occurs before or after the second alarm in terms of time can be determined, and therefore the time sequence information can be further determined.

Optionally, the determining, based on the historical alarm data, a quantity of times that the first alarm occurs before or after the second alarm at a preset time interval includes: determining, based on the historical alarm data, timestamps at which the first alarm and the second alarm separately occur at the preset time interval; and determining, based on the timestamps at which the first alarm and the second alarm separately occur at the preset time interval, the quantity of times that the first alarm occurs before or after the second alarm occurs at the preset time interval.

In a possible implementation, the determining a root cause alarm in the associated alarm combination based on the valid root cause rules includes: determining, in the valid root cause rules, a target root cause rule corresponding to the associated alarm combination, where alarms in the target root cause rule both exist in the associated alarm combination; and determining the root cause alarm in the associated alarm combination based on the target root cause rule.

It should be understood that, when the target root cause rule corresponding to the associated alarm combination is determined in the valid root cause rules, specifically, a root cause rule that is in the valid root cause rules and that includes any two alarms in the associated alarm combination is selected to obtain the target root cause rule corresponding to the associated alarm combination.

The target root cause rule corresponding to the associated alarm combination is selected from the valid root cause rules, so that a root cause rule closely related to the associated alarm combination can be directly selected from the valid root cause rules. Therefore, the root cause alarm in the associated alarm combination can be more pertinently located based on the target root cause rule.

In a possible implementation, the determining the root cause alarm in the associated alarm combination based on the target root cause rule includes: constructing a root cause decision network based on the target root cause rule; and determining the root cause alarm in the associated alarm combination according to the root cause decision network.

The foregoing root cause decision network is an alarm decision network including alarms in the target root cause rule.

The root cause decision network is constructed to determine the root cause alarm in the associated alarm combination more conveniently and directly.

In a possible implementation, the determining the root cause alarm in the associated alarm combination based on the target root cause rule includes: determining weight information of the target root cause rule based on the historical alarm data, where the weight information of the target root cause rule is used to indicate strength of a causal relationship between alarms in the target root cause rule; determining an impact factor of each alarm in the associated alarm combination based on the target root cause rule and the weight information of the target root cause rule; and determining the root cause alarm in the associated alarm combination based on the impact factor.

The impact factor of each alarm is used to indicate a degree of impact of each alarm on another alarm in the associated alarm combination.

The degree of impact of each alarm on another alarm in the associated alarm combination may be determined based on the weight coefficient of the target root cause rule, so that the root cause alarm in the associated alarm combination can be further relatively accurately determined based on the length of impact of each alarm on the another alarm.

Optionally, the determining weight information of the target root cause rule based on the historical alarm data includes: after the target root cause rule is obtained, directly determining the weight information of the target root cause rule based on the historical alarm data.

Optionally, the determining weight information of the target root cause rule based on the historical alarm data includes: before the target root cause rule is obtained, determining weight information of the candidate root cause rules or the valid root cause rules based on the historical alarm data; and obtaining the weight information of the target root cause rule from the weight information of the candidate root cause rules or the valid root cause rules.

In a possible implementation, the determining the root cause alarm in the associated alarm combination based on the impact factor includes: determining K alarms in the associated alarm combination as root cause alarms, where K is an integer greater than or equal to 1, and impact factors of the K alarms each are greater than or equal to an impact factor of any other alarm in the associated alarm combination rather than the K alarms.

In a possible implementation, the determining weight information of the target root cause rule based on the historical alarm data includes: determining, based on the historical alarm data, frequencies at which a third alarm and a fourth alarm of the target root cause rule separately occur in a plurality of time windows at the preset time interval; generating an occurrence frequency sequence of the third alarm based on the frequencies at which the third alarm separately occurs in the plurality of time windows at the preset time interval; generating an occurrence frequency sequence of the fourth alarm based on the frequencies at which the fourth alarm separately occurs in the plurality of time windows at the preset time interval; and determining the weight information of the target root cause rule based on a similarity between the occurrence frequency sequence of the third alarm and the occurrence frequency sequence of the fourth alarm.

According to a second aspect, a method for locating a root cause alarm on a telecommunications network is provided. The method includes: obtaining an alarm correlation rule of the telecommunications network; splitting the alarm correlation rule to obtain candidate root cause rules; determining time sequence information of the candidate root cause rules based on historical alarm data of the telecommunications network; determining weight information of the candidate root cause rules based on the historical alarm data, where the weight information of the candidate root cause rules is used to indicate strength of a causal relationship between a first alarm and a second alarm; determining valid root cause rules in the candidate root cause rules based on the time sequence information and the weight information of the candidate root cause rules; extracting an associated alarm combination from an alarm stream of the telecommunications network; and determining a root cause alarm in the associated alarm combination based on the valid root cause rules.

The candidate root cause rules each include a first alarm and a second alarm. The time sequence information of the candidate root cause rules is used to indicate a probability that the first alarm occurs before the second alarm in terms of time. There may be a plurality of candidate root cause rules. In other words, the plurality of candidate root cause rules may be obtained after the candidate root cause rules are split.

It should be understood that each candidate root cause rule includes two alarms. Specifically, each candidate root cause rule includes a first alarm and a second alarm. In addition, the first alarm may be an alarm that is in the front of the candidate root cause rule (or may be referred to as a first-order alarm or a pre-order alarm). The second alarm may be an alarm that is in the hack of the candidate root cause rule (or may be referred to as a post-order alarm).

Optionally, the splitting the alarm correlation rule to obtain candidate root cause rules specifically includes: splitting the alarm correlation rule to obtain a plurality of alarms; and combining the plurality of alarms in pairs to obtain the candidate root cause rules.

A candidate root cause rule that includes two alarms may be obtained by combining the plurality of alarms in the alarm root cause rule in pairs, so as to analyze a causal relationship between any two alarms in the alarm correlation rule.

In this application, valid root cause rules can be more accurately selected from the candidate root cause rules based on a probability that an alarm in each of the candidate root cause rules occurs before another alarm in terms of time and strength of a causal relationship between alarms in the candidate root cause rules. Therefore, the root cause alarm can be relatively accurately located based on the valid root cause rules.

In a possible implementation, the obtaining an alarm correlation rule of the telecommunications network includes: determining the alarm correlation rule of the telecommunications network based on the historical alarm data of the telecommunications network.

Specifically, the alarm correlation rule of the telecommunications network may be determined or generated by performing frequent item mining on the historical alarm data of the telecommunications network.

Optionally, the valid root cause rules are root cause rules whose the time sequence information and the weight information meet preset requirements.

In a possible implementation, when the time sequence information is a time sequence coefficient, and the weight information is a weight coefficient, the determining valid root cause rules in the candidate root cause rules based on the time sequence information and the weight information of the candidate root cause rules includes: determining, in the candidate root cause rules, root cause rules whose time sequence coefficients are within a first preset range and whose weight coefficients are within a second preset range as the valid root cause rules.

Optionally, a value range of the time sequence coefficients is [0, 1]. When the time sequence coefficient is 0, it indicates that the first alarm in the candidate root cause rule certainly does not occur before the second alarm. When the time sequence coefficient is 1, it indicates that the first alarm in the candidate root cause rule certainly occurs before the second alarm.

Optionally, a value range of the weight coefficients is [0, 1]. When the weight coefficient is 0, it indicates that occurrence of the first alarm in the candidate root cause rule certainly is not accompanied with occurrence of the second alarm. When the time sequence coefficient is 1, it indicates that occurrence of the first alarm in the candidate root cause rule certainly is accompanied with occurrence of the second alarm.

In a possible implementation, the determining, in the candidate root cause rules, root cause rules whose time sequence coefficients are within a first preset range and whose weight coefficients are within a second preset range as the valid root cause rules includes: determining, in the candidate root cause rules, root cause rules whose time sequence coefficients are greater than or equal to a first time sequence coefficient threshold and whose weight coefficients are greater than or equal to a first weight coefficient threshold as the valid root cause rules.

Optionally, the first time sequence coefficient threshold is 0.5, and the first weight coefficient threshold is 0.

In a possible implementation, the determining time sequence information of the candidate root cause rules based on historical alarm data of the telecommunications network includes: determining, based on the historical alarm data, a quantity of times that the first alarm occurs before or after the second alarm at a preset time interval; and determining the time sequence information of the candidate root cause rules based on the quantity of times that the first alarm occurs before or after the second alarm at the preset time interval.

The historical alarm data may be analyzed to learn of quantities of times that the first alarm and the second alarm occur at a past specific time interval and an occurrence sequence, so that a probability that the first alarm occurs before or after the second alarm in terms of time can be determined, and therefore the time sequence information can be further determined.

Optionally, the determining, based on the historical alarm data, a quantity of times that the first alarm occurs before or after the second alarm at a preset time interval includes: determining, based on the historical alarm data, timestamps at which the first alarm and the second alarm separately occur at the preset time interval; and determining, based on the timestamps at which the first alarm and the second alarm separately occur at the preset time interval, the quantity of times that the first alarm occurs before or after the second alarm occurs at the preset time interval.

In a possible implementation, determining weight information of initial root cause rules based on the historical alarm data includes: determining, based on the historical alarm data, frequencies at which a first alarm and a second alarm separately occur in a plurality of time windows at the preset time interval; generating an occurrence frequency sequence of the first alarm based on the frequencies at which the first alarm separately occurs in the plurality of time windows at the preset time interval; generating an occurrence frequency sequence of the second alarm based on the frequencies at which the second alarm separately occurs in the plurality of time windows at the preset time interval; and determining the weight information of the initial root cause rule based on a similarity between the occurrence frequency sequence of the first alarm and the occurrence frequency sequence of the second alarm.

In a possible implementation, the determining a root cause alarm in the associated alarm combination based on the valid root cause rules includes: determining, in the valid root cause rules, a target root cause rule corresponding to the associated alarm combination, where alarms in the target root cause rule both exist in the associated alarm combination; and determining the root cause alarm in the associated alarm combination based on the target root cause rule.

It should be understood that, when the target root cause rule corresponding to the associated alarm combination is determined in the valid root cause rules, specifically, a root cause rule that is in the valid root cause rules and that includes any two alarms in the associated alarm combination is selected to obtain the target root cause rule corresponding to the associated alarm combination.

The target root cause rule corresponding to the associated alarm combination is selected from the valid root cause rules, so that a root cause rule closely related to the associated alarm combination can be directly selected from the valid root cause rules. Therefore, the root cause alarm in the associated alarm combination can be more pertinently located based on the target root cause rule.

In a possible implementation, the determining the root cause alarm in the associated alarm combination based on the target root cause rule includes: determining an impact factor of each alarm in the associated alarm combination based on the target root cause rule and weight information of the target root cause rule, where the impact factor of each alarm is used to indicate a degree of impact of each alarm on another alarm in the associated alarm combination; and determining the root cause alarm in the associated alarm combination based on the impact factor.

The degree of impact of each alarm on another alarm in the associated alarm combination may be determined based on the weight coefficient of the target root cause rule, so that the root cause alarm in the associated alarm combination can be further relatively accurately determined based on the length of impact of each alarm on the another alarm.

In a possible implementation, the determining the root cause alarm in the associated alarm combination based on the impact factor includes: determining K alarms in the associated alarm combination as root cause alarms, where K is an integer greater than or equal to 1, and impact factors of the K alarms each are greater than or equal to an impact factor of any other alarm in the associated alarm combination rather than the K alarms.

According to a third aspect, a method for locating a root cause alarm on a telecommunications network is provided. The method includes: obtaining alarm correlation rule information; splitting an alarm correlation rule to generate candidate root cause rules; and obtaining historical alarm data; determining time sequence information of the candidate root cause rules based on the historical alarm data; selecting valid root cause rules from the candidate root cause rules based on the time sequence information to obtain valid root cause rule information corresponding to the valid root cause rules.

The alarm correlation rule information is used to indicate an alarm correlation rule. The alarm correlation rule may be obtained based on the alarm correlation rule information.

In this application, the valid root cause rules may be selected from the candidate root cause rules based on a probability that an alarm in each of the candidate root cause rules occurs before another alarm in terms of time (in other words, the valid root cause rules may be selected from the candidate root cause rules based on the time sequence information). In addition, the valid root cause rule information is generated. Therefore, the root cause alarm can be more accurately located based on the valid root cause rule information.

In a possible implementation, the method further includes: store the valid root cause rule information.

The valid root cause rule information is stored, so that the valid root cause rule information can be subsequently conveniently extracted to locate the root cause alarm.

In a possible implementation, the method further includes: extracting an associated alarm combination from an alarm stream of the telecommunications network; and determining a root cause alarm in the associated alarm combination based on valid root cause rules indicated by the valid root cause rule information.

The root cause alarm can be located by using the pre-obtained valid root cause rule information, so that efficiency of locating the root cause alarm can be improved.

According to a fourth aspect, a method for locating a root cause alarm on a telecommunications network is provided. The method includes: obtaining alarm correlation rule information; splitting an alarm correlation rule to generate candidate root cause rules; determining time sequence information of the candidate root cause rules based on historical alarm data; determining weight information of the candidate root cause rules based on the historical alarm data; and selecting valid root cause rules from the candidate root cause rules based on the time sequence information and the weight information to obtain valid root cause rule information corresponding to the valid root cause rules.

In this application, based on a probability that an alarm in each of the candidate root cause rules occurs before another alarm in terms of time and strength of a causal relationship between alarms in the candidate root cause rules, valid root cause rules can be relatively accurately selected from the candidate root cause rules, and the valid root cause rule information is generated, so that the root cause alarm can be more accurately located subsequently based on the valid root cause rule information.

In a possible implementation, the method further includes: store the valid root cause rule information.

The valid root cause rule information is stored, so that the valid root cause rule information can be subsequently conveniently extracted to locate the root cause alarm.

In a possible implementation, the method further includes: extracting an associated alarm combination from an alarm stream of the telecommunications network; and determining a root cause alarm in the associated alarm combination based on valid root cause rules indicated by the valid root cause rule information.

The root cause alarm can be located by using the pre-obtained valid root cause rule information, so that efficiency of locating the root cause alarm can be improved.

According to a fifth aspect, an apparatus for locating a root cause alarm is provided. The apparatus for locating the root cause alarm includes modules configured to perform the method according to the first aspect, the second aspect, the third aspect, or the fourth aspect.

According to a sixth aspect, an apparatus for locating a root cause alarm is provided. The apparatus for locating the root cause alarm includes a memory and a processor. The memory is configured to store a program, and the processor is configured to execute the program stored in the memory. When the program is executed, the processor is configured to perform the method according to the first aspect, the second aspect, the third aspect, or the fourth aspect.

Optionally, the memory includes a non-volatile storage medium. The non-volatile storage medium is configured to store a program.

Optionally, the processor is a central processing unit. The central processing unit is connected to the non-volatile storage medium, and is configured to execute the program stored in the non-volatile storage medium.

According to a seventh aspect, a computer-readable medium is provided. The computer-readable medium stores program code to be executed by a device. The program code is used to perform the method according to the first aspect, the second aspect, the third aspect, or the fourth aspect.

According to an eighth aspect, a computer program product including an instruction is provided. When the computer program product is run on a computer, the computer is enabled to perform the method according to the first aspect, the second aspect, the third aspect, or the fourth aspect.

According to a ninth aspect, a server is provided, including the apparatus for locating the root cause alarm according to the fifth aspect or the sixth aspect.

### BRIEF DESCRIPTION OF DRAWINGS

FIG. 1 is a schematic flowchart of a method for locating a root cause alarm on a telecommunications network according to an embodiment of this application;

FIG. 2 is a schematic diagram of occurrence of an alarm A and an alarm B in some time windows;

FIG. 3 is a schematic diagram of a root cause decision network;

FIG. 4 is a schematic diagram of quantities of times at which an alarm A and an alarm B occur in some time windows;

FIG. 5 is a schematic flowchart of a method for locating a root cause alarm on a telecommunications network according to an embodiment of this application;

FIG. 6 is a schematic diagram of a root cause decision network;

FIG. 7 is a schematic flowchart of a method for locating a root cause alarm on a telecommunications network according to an embodiment of this application;

FIG. 8 is a schematic flowchart of a method for locating a root cause alarm on a telecommunications network according to an embodiment of this application;

FIG. 9 is a schematic flowchart of a method for locating a root cause alarm on a telecommunications network according to an embodiment of this application;

FIG. 10 is a schematic diagram of occurrence of an alarm A and an alarm B in some time windows;

FIG. 11 is a schematic diagram of quantities of times at which an alarm A and an alarm B occur in some time windows;

FIG. 12 is a schematic flowchart of a method for locating a root cause alarm on a telecommunications network according to an embodiment of this application;

FIG. 13 is a schematic diagram of a root cause decision network;

FIG. 14 is a schematic flowchart of determining a root cause alarm in an associated alarm combination A₁A₂A₃A₄A₅A₆;

FIG. 15 is a schematic block diagram of an apparatus for locating a root cause alarm on a telecommunications network according to an embodiment of this application;

FIG. 16 is a schematic block diagram of an apparatus for locating a root cause alarm on a telecommunications network according to an embodiment of this application;

FIG. 17 is a schematic block diagram of an apparatus for locating a root cause alarm on a telecommunications network according to an embodiment of this application;

FIG. 18 is a schematic block diagram of an apparatus for locating a root cause alarm according to an embodiment of this application;

FIG. 19 is a schematic diagram of locating a root cause alarm by an apparatus for locating the root cause alarm according to an embodiment of this application; and

FIG. 20 is a schematic diagram of an application scenario according to an embodiment of this application.

### DESCRIPTION OF EMBODIMENTS

The following describes the technical solutions in this application with reference to the accompanying drawings.

A method for locating a root cause alarm on a telecommunications network according to the embodiments of this application may be applied to the telecommunications network, and is used to locate a root cause alarm in a telecommunications network device. The method for locating a root cause alarm on a telecommunications network according to the embodiments of this application may be performed by a server or a server cluster on the telecommunications network. The server on the telecommunications network may be a general-purpose computer system installed with a mainstream operating system (for example, Windows or Unix).

The foregoing telecommunications network may be a communications system in which a plurality of users communicate with each other, and is important infrastructure for long-distance communication. The telecommunications network delivers, transmits, and receives an identifier, a word, an image, a sound, or another signal by using a cable, radio, an optical fiber, or another electromagnetic system.

The telecommunications network may be generally divided into a plurality of domains. For example, if only a transmission network and a wireless network are considered, the telecommunications network may be divided into an access transport network (ATN) domain, a microwave (MW) domain, and a radio (radio access network, RAN) domain in terms of layers from top to bottom. The ATN domain may also be referred to as a data communications domain. Therefore, the telecommunications network device includes a device in the ATN domain, a device in the MW domain, a device in the RAN domain, and a device in another domain in terms of domain division.

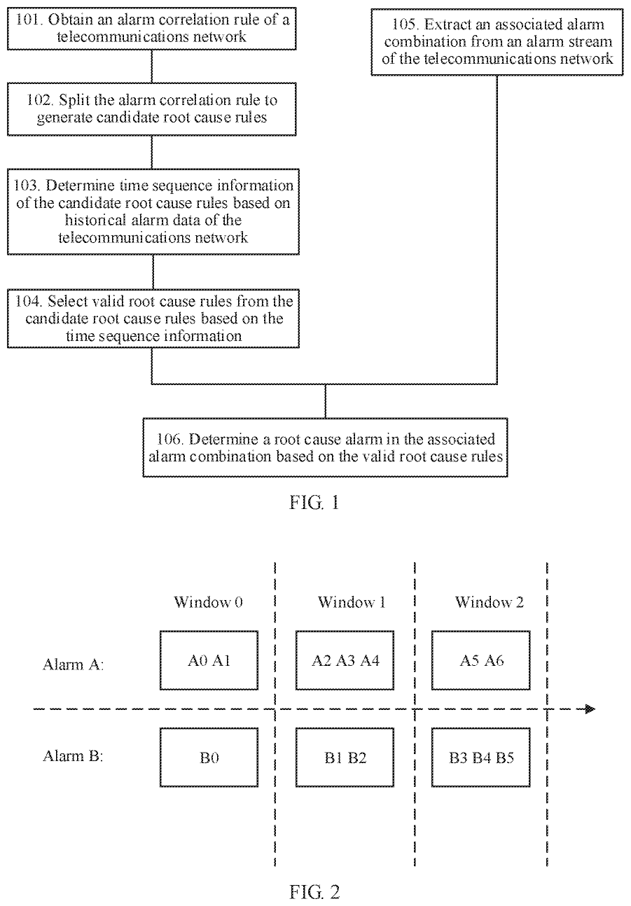

FIG. 1 is a schematic flowchart of a method for locating a root cause alarm on a telecommunications network according to an embodiment of this application. The method shown in FIG. 1 includes step 101 to step 106. There is no strict time sequence of step 104 and step 105. Step 105 may be performed before or after step 104, or step 104 and step 105 may be simultaneously performed. The following separately describes step 101 to step 106 in detail.

Step 101: Obtain an alarm correlation rule of the telecommunications network.

The alarm correlation rule may be preset, or may be obtained in real time. When the method shown in FIG. 1 is performed by a server, the alarm correlation rule may be preset in the server (for example, the alarm correlation rule is pre-stored in a memory). When the alarm correlation rule needs to be obtained, the alarm correlation rule may be directly invoked from the server.

In addition, the alarm correlation rule of the telecommunications network may also be obtained based on historical alarm data of the telecommunications network. Specifically, the historical alarm data of the telecommunications network may be first obtained, and then frequent item mining is performed on the historical alarm data to generate the alarm correlation rule of the telecommunications network.

Step 102: Split the alarm correlation rule to obtain candidate root cause rules.

Specifically, the alarm correlation rule may be split to obtain a plurality of alarms, and then the plurality of alarms are combined in pairs to obtain the candidate root cause rules.

The plurality of alarms in the alarm root cause rule may be combined in pairs to obtain the candidate root cause rules that each include two alarms, thereby helping to analyze a causal relationship between any two alarms in the alarm correlation rule.

For example, an alarm correlation rule ABC is split to obtain an alarm A, an alarm B, and an alarm C, and these alarms may be combined in pairs to obtain candidate root cause rules {A−>B, A−>C, B−>A, B−>C, C−>A, and C−>B}.

It can be teamed from the foregoing example that there may be a plurality of candidate root cause rules, and each candidate root cause rule includes two alarms.

Step 103: Determine time sequence information of the candidate root cause rules based on the historical alarm data of the telecommunications network.

The candidate root cause rules each include a first alarm and a second alarm, and the time sequence information of the candidate root cause rules is used to indicate a probability that the first alarm occurs before the second alarm in terms of time.

For example, in the candidate root cause rule A−>B in the foregoing example, A is the first alarm and B is the second alarm, or A is the second alarm and B is the first alarm, and time sequence information of the candidate root cause rule A−>B is used to indicate a probability that the alarm A occurs before the alarm B in terms of time.

In addition, the foregoing historical alarm data may be alarm data collected from devices on the telecommunications network within a period of time. The historical alarm data may include a device on which an alarm occurs, an alarm occurrence time, an alarm category, and the like.

Optionally, the determining time sequence information of the candidate root cause rules based on the historical alarm data of the telecommunications network includes: determining, based on the historical alarm data, a quantity of times that the first alarm occurs before or after the second alarm at a preset time interval; and determining the time sequence information of the candidate root cause rules based on the quantity of times that the first alarm occurs before or after the second alarm at the preset time interval.

The historical alarm data may be analyzed to learn of quantities of times that the first alarm and the second alarm occur at a past specific time interval and an occurrence sequence, so that a probability that the first alarm occurs before or after the second alarm in terms of time can be determined, and therefore the time sequence information can be further determined.

Specifically, when the quantity of times that the first alarm occurs before or after the second alarm at the preset time interval is determined based on the historical alarm data, timestamps at which the first alarm and the second alarm separately occur at the preset time interval may be first determined based on the historical alarm data; and then the quantity of times that the first alarm occurs before or after the second alarm at the preset time interval may be determined based on a sequence of the timestamps at which the first alarm and the second alarm separately occur at the preset time interval.

When the quantity of times that the first alarm occurs before or after the second alarm at the preset time interval is determined, the preset time interval may be divided into a plurality of time windows then a quantity of times that the alarm A occurs before the alarm B in each time window is determined; and finally the quantity of times that the first alarm occurs before or after the second alarm at the preset time interval is obtained.

The preset time interval may be a relatively long time, and each time window may be a very short time. For example, the time interval may be three months, and the time window may be obtained by dividing the preset time interval at intervals of five minutes.

For example, when the time sequence information of the candidate root cause rule A−>B needs to be determined, the preset time interval may be first divided into a plurality of time windows; then timestamps at which the alarm A and the alarm B separately occur in each time window are determined based on the historical alarm data to obtain situations in which the alarm A and the alarm B occur in each time window and finally a quantity of times that the alarm A occurs before the alarm B at the preset time interval may be obtained by comprehensively considering the situations in which the alarm A and the alarm B occur in each time window, to obtain the time sequence information of the candidate root cause rule A−>B.

FIG. 2 shows situations in which the alarm A and the alarm B occur in some time windows (a window 0 to a window 2). Specifically, in the window 0 to the window 2. the situations in which the alarm A and the alarm B occur are as follows:

In the window 0, the alarm A occurs twice, and the alarm B occurs once.

In the window 1, the alarm A occurs three times, and the alarm B occurs twice.

In the window 2, the alarm A occurs twice, and the alarm B occurs three times.

In the window 0, A0 to A6 separately record timestamps at which the alarm A occurs on different time windows, and B0 to B5 separately record timestamps at which the alarm B occurs on different time windows.

Timestamps at which the alarm A and the alarm B occur in the window 0 may be separately analyzed to obtain a quantity of times that the alarm A occurs before the alarm B in the time window 0. A quantity of times that the alarm A occurs before the alarm B on another time window may be obtained in a similar manner. Quantities of times that the alarm A occurs before the alarm B in all time windows are summed up to obtain the quantity of times that the alarm A occurs before the alarm B at the preset time interval. Finally, the time sequence information of the candidate root cause rule A−>B may be obtained based on the quantity of times that the alarm A occurs before the alarm B at the preset time interval.

Step 104: Determine valid root cause rules in the candidate root cause rules based on the time sequence information of the candidate root cause rules.

The valid root cause rules may be root cause rules whose time sequence information meets a preset requirement. Therefore, the root cause rules whose time sequence information meets the preset requirement may be selected from the candidate root cause rules as the valid root cause rules.

The time sequence information may be specifically represented by a time sequence coefficient, and the time sequence coefficient may indicate validity of the candidate root cause rules. For example, a larger time sequence coefficient of the candidate root cause rules indicates a higher probability that the first alarm of the candidate root cause rule occurs before the second alarm in terms of time, and higher validity of the candidate root cause rules. A smaller time sequence coefficient of the candidate root cause rules indicates a lower probability that the first alarm of the candidate root cause rule occurs before the second alarm in terms of time, and lower validity of the candidate root cause rules.

Optionally, a value range of the time sequence coefficients is [0, 1]. When the time sequence coefficient is 0, it indicates that the first alarm in the candidate root cause rule certainly does not occur before the second alarm (a probability that the first alarm occurs before the second alarm is 0). When the time sequence coefficient is 1, it indicates that the first alarm in the candidate root cause rule certainly occurs before the second alarm (a probability that the first alarm occurs before the second alarm is 1).

Specifically, when the time sequence information is the time sequence coefficient, the valid root cause rules may be selected from the candidate root cause rules based on the time sequence coefficient.

Optionally, in an embodiment, the determining valid root cause rules in the candidate root cause rules includes: determining, in the candidate root cause rules, root cause rules whose time sequence coefficients are within a preset range as the valid root cause rules.

Root cause rules (in other words, the valid root cause rules)whose validity meets a requirement may be selected from the candidate root cause rules based on whether the time sequence coefficients are within the preset range, so as to subsequently locate root cause alarms based on these root cause rules with relatively high validity.

Specifically, root cause rules whose time sequence coefficients each are greater than or equal to a first time sequence coefficient threshold may be determined in the candidate root cause rules as the valid root cause rules.

The first time sequence coefficient threshold may be 0.5. Therefore, when a time sequence coefficient of a specific candidate root cause rule is greater than or equal to 0.5, the candidate root cause rule may be selected as the valid root cause rule.

Step 105: Extract an associated alarm combination from an alarm stream of the telecommunications network.

Alarms in the foregoing associated alarm combination are associated with each other. Generally, a plurality of associated alarms in the alarm stream may be extracted by using an alarm compression technology, to obtain the associated alarm combination.

Further, in an actual service scenario of the telecommunications network, a customer usually pays more attention to some alarms that are strongly related to a service. Therefore, alarms that are in the alarm stream and that are related to the service may be combined by using the alarm compression technology, to obtain the associated alarm combination.

Step 106: Determine a root cause alarm in the associated alarm combination based on the valid root cause rules.

Specifically, the root cause alarm in the associated alarm combination may be determined based on a causal relationship between different alarms in the valid root cause rules.

For example, if the associated alarm combination is ABC and the valid root cause rules are {A−>B, A−>C, B−>D, C−>E, and D−>F}, it can be learned, based on the valid root cause rules, that occurrence of the alarm A is accompanied with occurrence of the alarm B and the alarm C. Therefore, the alarm A can be determined as a root cause alarm in the associated alarm combination ABC.

In this application, the valid root cause rules may be selected from the candidate root cause rules based on a probability that an alarm in each of the candidate root cause rules occurs before another alarm in terms of time (in other words, the valid root cause rules may be selected from the candidate root cause rules based on the time sequence information). Therefore, the root cause alarm can be more accurately located based on the valid root cause rules.

It should be understood that, when the root cause alarm in the associated alarm combination is determined based on the valid root cause rules, root cause alarms related to the associated alarm combination may be first selected from the valid root cause rules, and then the root cause alarm in the associated alarm combination is determined based on these root cause alarms.

Optionally, in an embodiment, the determining a root cause alarm in the associated alarm combination based on the valid root cause rules includes: determining, in the valid root cause rules, a target root cause rule corresponding to the associated alarm combination; and determining the root cause alarm in the associated alarm combination based on the target root cause rule.

Alarms in the target root cause rule both exist in the associated alarm combination.

For example, the associated alarm combination is ABC, and the valid root cause rules are {A−>B, A−>C, B−>D, C−>E, and D−>F}. The alarm A and the alarm B in the root cause rule A−>B both exist in the associated alarm combination ABC. Similarly, the alarm A and an alarm C in the root cause rule A−>C both exist in the associated alarm combination ABC. Therefore, the root cause rule A−>B and the root cause rule A−>C may be selected from the valid root cause rules to obtain the target root cause rules {A−>B and A−>C}.

The target root cause rule corresponding to the associated alarm combination is selected from the valid root cause rules, so that a root cause rule closely related to the associated alarm combination can be directly selected from the valid root cause rules. Therefore, the root cause alarm in the associated alarm combination can be more pertinently located based on the target root cause rule.

Further, to more conveniently locate the root cause alarm in the associated alarm combination based on the target root cause rules, a root cause decision network may be first constructed based on the target root cause rule, and then the root cause alarm in the associated alarm combination is located based on the root cause decision network.

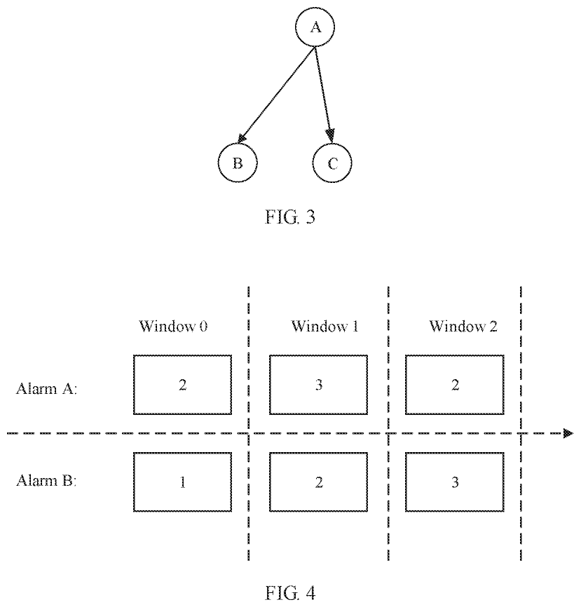

For example, if the associated alarm combination is ABC, and the target root cause rules are {A−>B, and A−>C}, a simple root cause decision network may be constructed based on the target root cause rule. The root cause decision network is shown in FIG. 3. It can be very conveniently determined, based on the root cause decision network shown in FIG. 3, that the alarm A is the root cause alarm in the associated alarm combination ABC.

The root cause decision network is constructed to determine the root cause alarm in the associated alarm combination more conveniently and directly.

In this application, in addition to directly determining the root cause alarm in the associated alarm combination based on the target root cause rule, weight information of the target root cause rule may be first obtained, and then the root cause alarm in the associated alarm combination is determined based on the target root cause rule and the weight information of the target root cause rule.

Optionally, in an embodiment, the method shown in FIG. 1 further includes: determining weight information of the target root cause rule based on the historical alarm data. The weight information of the target root cause rule is used to indicate strength of a causal relationship between alarms in the target root cause rule.

It should be understood that the weight information of the target root cause rule is obtained in two manners. In a first manner, after the target root cause rule is obtained, the weight information of the target root cause rule is directly determined based on the historical alarm data. In a second manner, before the target root cause rule is obtained, weight information of the candidate root cause rules or the valid root cause rules is determined based on the historical alarm data. Therefore, after the target root cause rule is obtained, the weight information of the target root cause rule may be directly obtained from the weight information of the candidate root cause rules or the valid root cause rules.

In other words, the weight information of the target root cause rule may be determined after or before the target root cause rule is determined in the valid root cause rules.

Specifically, the weight information of the target root cause rule may be determined in the following processes.

First, frequencies at which a third alarm and a fourth alarm in the target root cause rule separately occur in a plurality of time windows at the preset time interval are determined based on the historical alarm data.

Second, an occurrence frequency sequence of the third alarm is generated based on the frequencies at which the third alarm separately occurs in the plurality of time windows at the preset time interval.

Third, an occurrence frequency sequence of the fourth alarm is generated based on the frequencies at which the fourth alarm separately occurs in the plurality of time windows at the preset time interval.

Finally, the weight information of the target root cause rule is determined based on a similarity between the occurrence frequency sequence of the third alarm and the occurrence frequency sequence of the fourth alarm.

The weight information of the candidate root cause rules or the valid root cause rules may also be directly determined in the foregoing manner of determining the weight coefficient of the target root cause rule.

It should be understood that a higher similarity between the occurrence frequency sequence of the third alarm and the occurrence frequency sequence of the fourth alarm indicates a stronger causal relationship between the third alarm and the fourth alarm, and a lower similarity between the occurrence frequency sequence of the third alarm and the occurrence frequency sequence of the fourth alarm indicates a weaker causal relationship between the third alarm and the fourth alarm.

It should be understood that frequencies at which an alarm occurs in a plurality of time windows at a preset time interval may be specifically quantities of tunes that the alarm occurs in the plurality of time windows at the preset time interval.

For example, when weight information of the target root cause rule A−>B needs to be determined, the preset time interval may be first divided into a plurality of time windows; then quantities of times that the alarm A and the alarm B separately occur in each time window are determined based on the historical alarm data; and finally frequency sequences of the alarm A and the alarm B can be obtained by comprehensively considering the quantities of times that the alarm A and the alarm B occur in each time window.

FIG. 4 shows quantities of times that the alarm A and the alarm B occur in sonic time windows (a window 0 to a window 2). Specifically, the alarm A respectively occurs twice, three times, and twice in the window 0 to the window 2, and the alarm A respectively occurs once, twice, and three times in the window 0 to the window 2.

Assuming that the preset time interval includes only the window 0 to the window 2, an occurrence frequency sequence of the alarm A is 2 3 2, and an occurrence frequency sequence of the alarm B is 1 2 3. Then, the weight information of the target root cause rule may be determined based on a similarity between the frequency sequence 2 3 2 and the frequency sequence 1 2 3.

After the weight information of the target root cause rule is obtained, the root cause alarm in the associated alarm combination may be directly determined based on the target root cause rule and the weight information of the target root cause rule.

Optionally, in an embodiment, the determining the root cause alarm in the associated alarm combination based on the target root cause rule includes: determining an impact factor of each alarm in the associated alarm combination based on the target root cause rule and the weight information of the target root cause rule; and determining the root cause alarm in the associated alarm combination based on the impact factor.

The impact factor of each alarm is used to indicate a degree of impact of each alarm on another alarm in the associated alarm combination.

It should be understood that a degree of impact of an alarm on another alarm may be a probability that occurrence of the alarm causes occurrence of another alarm. For example, when the alarm A imposes an extremely great impact on the alarm B, occurrence of the alarm A probably causes occurrence of the alarm B.

For example, in the associated alarm combination ABC, an impact factor of the alarm A is used to indicate degrees of impact of the alarm A on the alarm B and the alarm C in the associated alarm ABC. If the impact factor of the alarm A is greater than an impact factor of the alarm B and an impact factor of the alarm C, it may be considered that, in the alarm A, the alarm B, and the alarm C, the alarm A imposes the greatest impact on other alarms in the associated alarm combination ABC, and the alarm A may be determined as the root cause alarm in the associated alarm combination ABC.

When the root cause alarm in the associated alarm combination is determined based on the impact factor, an alarm with a maximum impact factor may be determined as the root cause alarm in the associated alarm combination, or several alarms with maximum impact factors may be determined as the root cause alarms in the associated alarm combination.

Optionally, in an embodiment, the determining the root cause alarm in the associated alarm combination based on the impact factor includes: determining K alarms in the associated alarm combination as the root cause alarms, where K is an integer greater than or equal to 1, and impact factors of the K alarms each are greater than or equal to an impact factor of any other alarm in the associated alarm combination rather than the K alarms.

The foregoing manner of selecting the root cause alarm may also be understood as that K alarms with maximum impact factors are selected from the associated alarm as the root cause alarms. When K is 1, an alarm with a maximum impact factor in the associated alarm combination is determined as the root cause alarm in the associated alarm combination. When K is greater than 1, several alarms with maximum impact factors in the associated alarm combination are determined as the root cause alarms in the associated alarm combination.

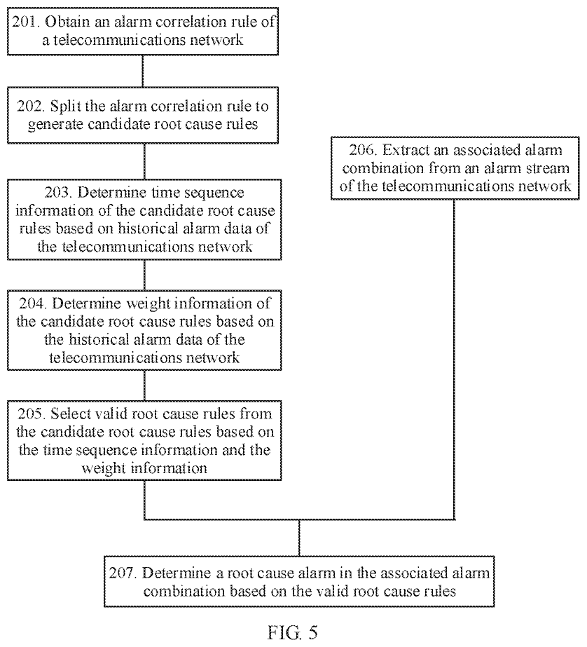

To select root cause rules that are more valid from the candidate root cause rules, the valid root cause rules may be selected from the candidate root cause rules based on the time sequence information and the weight information of the candidate root cause rules. Therefore, an embodiment of this application provides another method for locating a root cause alarm on a telecommunications network. The following describes the method in detail with reference to FIG. 5.

FIG. 5 is a schematic flowchart of a method for locating a root cause alarm on a telecommunications network according to an embodiment of this application. The method shown in FIG. 5 includes step 201 to step 206. There is no strict time sequence of step 204 and step 205. Step 205 may be performed before or after step 204, or step 204 and step 205 may be simultaneously performed. The following separately describes step 201 to step 206 in detail.

It should be understood that, content of step 201 to step 203 in the method shown in FIG. 5 is substantially the same as the content of step 101 to step 103 in the method shown in FIG. 1 (Content for determining time sequence information of the candidate root cause rules in step 203 is the same as the content for determining the time sequence information of the candidate root cause rules in step 103). The foregoing limitation and explanation on step 101 to step 103 are also applicable to step 201 to step 203. Similarly, content of step 205 and step 206 is respectively substantially the same as the content of step 105 and step 106. The foregoing limitation and explanation on step 105 and step 106 are also applicable to step 205 and step 206. Therefore, for brevity, repeated descriptions are appropriately omitted in the following when each step of the method shown in FIG. 5 is described.

Step 201: Obtain an alarm correlation rule of the telecommunications network.

When the method shown in FIG. 5 is performed by a server, the alarm correlation rule may be preset on the server. For example, the alarm correlation rule is preset in a memory of the server. When step 201 is performed, the alarm correlation rule may be directly obtained from the memory of the server. In addition, the alarm correlation rule may also be obtained by the server in real time. Specifically, the server may obtain the alarm correlation rule of the telecommunications network based on historical alarm data of the telecommunications network. When the alarm correlation rule is obtained based on the historical alarm data, the historical alarm data of the telecommunications network may be first obtained, and then frequent item mining is performed on the historical alarm data to generate the alarm correlation rule of the telecommunications network.

Step 202: Split the alarm correlation rule to obtain candidate root cause rules.

Specifically, the alarm correlation rule may be split first, and then alarms obtained by splitting the alarm correlation rule are combined in pairs to obtain the candidate root cause rules.

A candidate root cause rule that includes two alarms may be obtained by combining the plurality of alarms in the alarm root cause rule in pairs, so as to analyze a causal relationship between any two alarms in the alarm correlation rule.

For example, an alarm correlation rule ABCD is split to obtain an alarm A, an alarm B, an alarm C, and an alarm D, and then the four alarms may be combined in pairs to obtain candidate rules {A−>B, A−>C, B−>A, C−>B, C−>D, D−>A, D−>B, and D−>C}.

It can be known from the foregoing example that there may be a plurality of candidate root cause rules (12 candidate root cause rules may be obtained based on the alarm correlation rule ABCD), and each candidate root cause rule includes two alarms.

Step 203: Determine time sequence information of the candidate root cause rules based on the historical alarm data of the telecommunications network.

The candidate root cause rules each include a first alarm and a second alarm. The time sequence information of the candidate root cause rules is used to indicate a probability that the first alarm occurs before the second alarm in terms of time.

The candidate root cause rule A−>B is used as an example. A is a first alarm and B is a second alarm, or A is a second alarm and B is a first alarm. Therefore, determining time sequence information of the candidate root cause rule A−>B is essentially determining a probability that the alarm A (or the alarm B) occurs before the alarm B (or the alarm A) in terms of time.

In this application, a probability that the first alarm occurs before the second alarm in terms of time may be obtained by analyzing the historical alarm data, so as to determine the time sequence information of the candidate root cause rules.

Specifically, a quantity of times that the first alarm occurs before or after the second alarm at a preset time interval may be first determined based on the historical alarm data. Then, the time sequence information of the candidate root cause rules is determined based on the quantity of times that the first alarm occurs before or after the second alarm at the preset time interval.

For example, at a time interval, the first alarm and the second alarm both occur 10 times. The first alarm occurs before the second alarm seven times, and the first alarm occurs after the second alarm three times. In this case, when the time sequence information is specifically a time sequence coefficient, it may be determined that the time sequence coefficient of the candidate rule alarm is 0.7. The time sequence coefficient being greater than 0.5 indicates that the quantity of times that the first alarm occurs before the second alarm is greater than the quantity of times that the second alarm occurs before the first alarm.

The historical alarm data may be analyzed to learn of quantities of times that the first alarm and the second alarm occur at a past specific time interval and an occurrence sequence, so that a probability that the first alarm occurs before or after the second alarm in terms of time can be determined, and therefore the time sequence information can be further determined.

Specifically, when the quantity of times that the first alarm occurs before or after the second alarm at the preset time interval is determined based on the historical alarm data, timestamps at which the first alarm and the second alarm separately occur at the preset time interval may be determined based on the historical alarm data; and then the quantity of times that the first alarm occurs before or after the second alarm at the preset time interval may be determined based on a sequence of the timestamps at which the first alarm and the second alarm separately occur at the preset time interval.

Step 204: Determine weight information of the candidate root cause rules based on the historical alarm data, where the weight information of the candidate root cause rules is used to indicate strength of a causal relationship between the first alarm and the second alarm.

Specifically, the weight information of the candidate root cause rules may be determined in the following processes.

First, frequencies at which the first alarm and the second alarm of the candidate root cause rule separately occur in a plurality of time windows at the preset time interval are determined based on the historical alarm data.

Second, an occurrence frequency sequence of the first alarm is generated based on the frequencies at which the first alarm separately occurs in the plurality of time windows at the preset time interval.

Third, an occurrence frequency sequence of the second alarm is generated based on the frequencies at which the second alarm separately occurs in the plurality of time windows at the preset time interval.

Finally, the weight information of le candidate root cause rules is determined based on a similarity between the occurrence frequency sequence of the first alarm and the occurrence frequency sequence of the second alarm.

It should be understood that a higher similarity between the occurrence frequency sequence of the first alarm and the occurrence frequency sequence of the second alarm indicates a stronger causal relationship between the first alarm and the second alarm. A lower similarity between the occurrence frequency sequence of the first alarm and the occurrence frequency sequence of the second alarm indicates a weaker causal relationship between the first alarm and the second alarm.

Step 205: Determine valid root cause rules in the candidate root cause rules based on the time sequence information and the weight information of the candidate root cause rules.

Optionally, when the time sequence information is a time sequence coefficient, and the weight information is a weight coefficient, the determining valid root cause rules in the candidate root cause rules based on the time sequence information and the weight information of the candidate root cause rules specifically includes: determining, in the candidate root cause rules, root cause rules whose time sequence coefficients are within a first preset range and whose weight coefficients are within a second preset range as the valid root cause rules.

A value range of the time sequence coefficients may be [0, 1]. When the time sequence coefficient is 0, it indicates that the first alarm in the candidate root cause rule certainly does not occur before the second alarm (a probability that the first alarm occurs before the second alarm is 0). When the time sequence coefficient is 1, it indicates that the first alarm in the candidate root cause rule certainly occurs before the second alarm (a probability that the first alarm occurs before the second alarm is 1).

A value range of the weight coefficients may be [0, 1]. When the weight coefficient is 0, it indicates that the first alarm in the candidate root cause rules certainly does not cause the second alarm to occur (a probability that the first alarm causes the second alarm to occur is 0). When the time sequence coefficient is 1, it indicates that the first alarm in the candidate root cause rules certainly causes the second alarm to occur (a probability that the first alarm causes the second alarm to occur is 1).

Optionally, the determining, in the candidate root cause rules, root cause rules whose time sequence coefficients are within a first preset range and whose weight coefficients are within a second preset range as the valid root cause rules includes: determining, in the candidate root cause rules, root cause rules whose time sequence coefficients are greater than or equal to a first time sequence coefficient threshold and whose weight coefficients are greater than or equal to a first weight coefficient threshold as the valid root cause rules.

The first time sequence coefficient threshold may be 0.5, and the first weight coefficient threshold may be 0.

It should be understood that in step 205, the valid root cause rules are selected from the candidate root cause rules by comprehensively considering the time sequence information and the weight information, while in step 104, the valid root cause rules are selected from the candidate root cause rules by considering only the time sequence information. Compared with step 104, in step 205, root cause rules that are more valid may be selected from the candidate root cause rules as the valid root cause rules based on the time sequence information and the weight information.

Step 206: Extract an associated alarm combination from an alarm stream of the telecommunications network.

A correlation usually exists between alarms in the associated alarm combination. Generally, a plurality of associated alarms in the alarm stream may be extracted by using an alarm compression technology, to obtain the associated alarm combination. In an actual service scenario of the telecommunications network, a customer usually pays more attention to some alarms that are strongly related to a service. Therefore, alarms that are in the alarm stream and that are related to the service may be combined by using the alarm compression technology, to obtain the associated alarm combination.

Step 207: Determine a root cause alarm the associated alarm combination based on the valid root cause rules.

Specifically, the root cause alarm in the associated alarm combination may be determined based on a causal relationship between different alarms in the valid root cause rules.

For example, an associated alarm combination is ABC, and valid root cause rules are {A−>B, A−>C, B−>D, C−>E, and D−>F}. In this case, it can be learned that based on the valid root cause rules, occurrence of the alarm A may be accompanied with the alarm B. Similarly, occurrence of the alarm A may also be accompanied. with occurrence of the alarm C. Therefore, it can be determined. that the alarm A is a root cause alarm in the associated alarm combination ABC.

In addition, the root cause alarm in the associated combination may also be determined based on the causal relationship between different alarms in the valid root cause rules and the weight information of the valid root cause rules.

In this application, valid root cause rules can be more accurately selected from the candidate root cause rules based on a probability that an alarm in each of the candidate root cause rules occurs before another alarm in terms of time and strength of a causal relationship between alarms in the candidate root cause rules. Therefore, the root cause alarm can be relatively accurately located based on the valid root cause rules.

When the root cause alarm in the associated alarm combination is determined based on the valid root cause rules, a target root cause alarm related to the associated alarm combination may be first selected from the valid root cause rules, and then the root cause alarm in the associated alarm combination is determined based on the target root cause alarm.

Optionally, in an embodiment, the determining a root cause alarm in the associated alarm combination based on the valid root cause rules includes: determining, in the valid root cause rules, a target root cause rule corresponding to the associated alarm combination, where alarms in the target root cause rule both exist in the associated alarm combination; and determining the root cause alarm in the associated alarm combination based on the target root cause rule.

For example, the associated alarm combination is ABCD, and the valid root cause rules are {A−>B, A−>C, C−>D, C−>E, and D−>F}. The alarm A and the alarm B in the root cause rule A−>B both exist in the associated alarm combination ABCD. Similarly, the alarms in the root cause rules A−>C and C−>D also exist in the associated alarm combination ABCD. Therefore, the root cause rules A−>B, A−>C, and C−>D may be selected from the valid root cause rules to obtain the target root cause rules {A−>B, A−>C, and C−>D}.

The target root cause rule corresponding to the associated alarm combination is selected from the valid root cause rules, so that a root cause rule closely related to the associated alarm combination can be directly selected from the valid root cause rules. Therefore, the root cause alarm in the associated alarm combination can be more pertinently located based on the target root cause rule.

Further, to more conveniently locate the root cause alarm in the associated alarm combination based on the target root cause rules, a root cause decision network may be first constructed based on the target root cause rule, and then the root cause alarm in the associated alarm combination is located based on the root cause decision network.

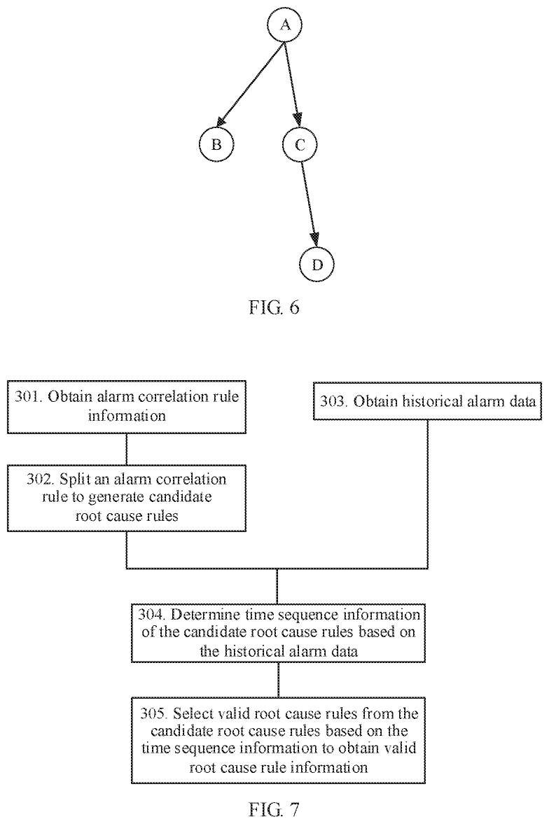

For example, if the associated alarm combinations ABCD, and the target root cause rules are {A−>B, A−>C, and C−>D}, a simple root cause decision network may be constructed based on the target root cause rules, The root cause decision network is shown in FIG. 6. It can be very conveniently determined, based on the root cause decision network shown in FIG. 6, that the alarm A is a root cause alarm in the associated alarm combination ABCD.

Optionally, in an embodiment, the determining the root cause alarm in the associated alarm combination based on the target root cause rule includes: determining an impact factor of each alarm in the associated alarm combination based on the target root cause rule and the weight information of the target root cause rule; and determining the root cause alarm in the associated alarm combination based on the impact factor.

The impact factor of each alarm is used to indicate a degree of impact of each alarm on another alarm in the associated alarm combination.

For example, for the associated alarm combination ABCD, an impact factor of the alarm A is used to indicate impact of the alarm A on the alarm B, the alarm C, and the alarm C that are in the associated alarm ABCD. If the impact factor of the alarm A is greater than impact factors of the other alarms in the associated alarm combination ABCD, it can be considered that, in the alarm A, the alarm B, the alarm C, and the alarm D, the alarm A imposes the greatest impact on the other alarms in the associated alarm combination ABCD. Therefore, the alarm A can be determined as a root cause alarm in the associated alarm combination ABCD.

When the root cause alarm in the associated alarm combination is determined based on an impact factor, an alarm with a maximum impact factor may be determined as the root cause alarm in the associated alarm combination, or several alarms with maximum impact factors may be determined as root cause alarms in the associated alarm combination.

Optionally, in an embodiment, the determining the root cause alarm in the associated alarm combination based on the impact factor includes: determining K alarms in the associated alarm combination as root cause alarms, where K is an integer greater than or equal to 1, and impact factors of the K alarms each are greater than or equal to an impact factor of any other alarm in the associated alarm combination rather than the K alarms.

The foregoing manner of selecting the root cause alarm may also be understood as selecting K alarms that are with maximum impact factors and that are from the associated alarm as the root cause alarms. When K is 1, an alarm that is with a maximum impact factor and that is in the associated alarm combination is determined as the root cause alarm in the associated alarm combination, When K is greater than 1, several alarms that are with maximum impact factors and that are in the associated alarm combination are determined as root cause alarms in the associated alarm combination.

It should be understood that, in this application, after the valid root cause rules are determined, in addition to directly determining the root cause alarm in the associated alarm combination based on the valid root cause rules, valid root cause rule information may be further generated. The valid root cause rule information is stored for locating a root cause alarm. Alternatively, the valid root cause rule information may be transmitted to a telecommunications network device, so that the telecommunications network device can locate the root cause alarm based on the valid root cause rule information.

FIG. 7 is a schematic flowchart of a method for locating a root cause alarm on a telecommunications network according to an embodiment of this application. The method shown in FIG. 7 includes the following steps:

Step 301: Obtain alarm correlation rule information.

When the method shown in FIG. 7 is performed by a server, the alarm correlation rule information may be information pre-stored in a memory or a storage module- of the server. When step 301 is performed, the alarm correlation rule information may be directly obtained from the memory. The alarm correlation rule information is specifically used to indicate an alarm correlation rule. Therefore, after the alarm correlation rule information is obtained, the alarm correlation rule can be obtained.

Step 302: Split the alarm correlation rule to generate candidate root cause rules.

Content in step 302 is essentially the same as the content in step 101 and step 202 in the foregoing description, and the definitions, explanations, and extensions of step 102 and step 202 in the foregoing description are also applicable to step 302.

Step 303: Obtain historical alarm data.

When the method shown in FIG. 7 is performed by the server, the historical alarm data may be obtained from the memory or the storage module of the server.

Step 304: Determine time sequence information of the candidate root cause rules based on the historical alarm data.

Step 305: Select valid root cause rules from the candidate root cause rules based on the time sequence information, to obtain valid root cause rule information corresponding to the valid root cause rules.

The content of step 304 and step 305 is respectively essentially the same as the content of step 103 and step 104. The foregoing limitations, explanations, and extensions of step 103 and step 104 are also applicable to step 304 and step 305.

In this application, when the valid root cause rules are selected from the candidate root cause rules, in addition to selecting based on the time sequence information, the valid root cause rules may be further selected from the candidate root cause rules based on the time sequence information and weight information of the candidate root cause rules.

Optionally, the method shown in FIG. 7 further includes: store the valid root cause rule information.

Specifically, when the method shown in FIG. 7 is performed by the server, the valid root cause rule information may be stored in the memory or the storage module of the server.

The valid root cause rule information is stored, so that the valid root cause rule information can be subsequently conveniently extracted to locate the root cause alarm.

Optionally, the method shown in FIG. 7 further includes: extracting an associated alarm combination from an alarm stream of the telecommunications network; and determining a root cause alarm in the associated alarm combination based on valid root cause rules indicated by the valid root cause rule information.

The root cause alarm can be located by using the pre-obtained valid root cause rule information, so that efficiency of locating the root cause alarm can be improved.

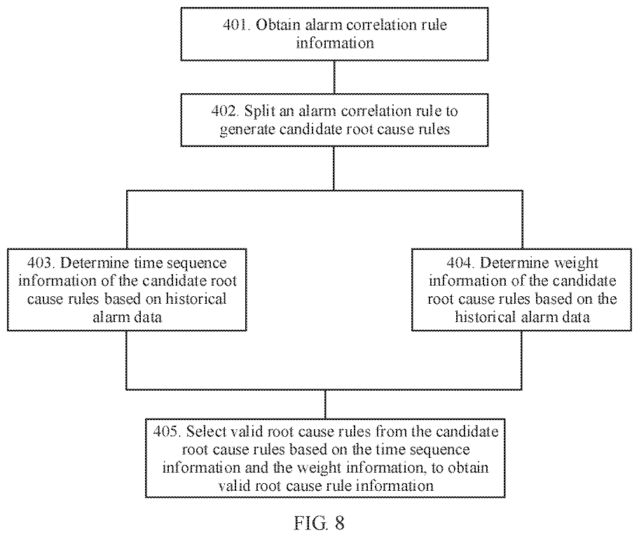

FIG. 8 is a schematic flowchart of a method for locating a root cause alarm on a telecommunications network according to an embodiment of this application. The method shown in FIG. 8 includes the following steps:

Step 401: Obtain alarm correlation rule information.

When the method shown in FIG. 8 is performed by a server, the alarm correlation rule information may be information pre-stored in a memory or a storage module of the server. When step 401 is performed, the alarm correlation rule information may be directly obtained from the memory. The alarm correlation rule information is specifically used to indicate an alarm correlation rule. Therefore, after the alarm correlation rule information is obtained, the alarm correlation rule can be obtained.

Step 402: Split the alarm correlation rule to generate candidate root cause rules.

The definitions, explanations, and extensions of step 102 and step 202 in the foregoing description are also applicable to step 402.

Step 403: Determine time sequence information of the candidate root cause rules based on historical alarm data.

Step 404: Determine weight information of the candidate root cause rules based on the historical alarm data.

The definition, explanation, and extension of the step 203 in the foregoing description are also applicable to the step 403 and the step 404.

Step 405: Select valid root cause rules from the candidate root cause rules based on the time sequence information and the weight information, to obtain valid root cause rule information.

The definition, explanation, and extension of the step 205 in the foregoing description are also applicable to the step 405.

In this application, based on a probability that an alarm in each of the candidate root cause rules occurs before another alarm in terms of time and strength of a causal relationship between alarms in the candidate root cause rules, valid root cause rules can be relatively accurately selected from the candidate root cause rules, and the valid root cause rule information is generated, so that the root cause alarm can be more accurately located subsequently based on the valid root cause rule information.

Optionally, in an embodiment, the method shown in FIG. 8 further includes: store the valid root cause rule information.

Specifically, When the method shown in FIG. 8 is performed by the server, the valid root cause rule information may be stored in the memory or the storage module of the server.

The valid root cause rule information is stored, so that the valid root cause rule information can be subsequently conveniently extracted to locate the root cause alarm.

In a possible implementation, the method shown in FIG. 8 further includes: extracting an associated alarm combination from an alarm stream of the telecommunications network; and determining a root cause alarm in the associated alarm combination based on valid root cause rules indicated by the valid root cause rule information.

The root cause alarm can be located by using the pre-obtained valid root cause rule information, so that efficiency of locating the root cause alarm can be Unproved.

To better understand the method for locating the root cause alarm on the telecommunications network in this embodiment of this application, the following describes in detail the method for locating the root cause alarm on the telecommunications network in this embodiment of this application with reference to a specific embodiment.

A whole process of the method for locating the root cause alarm on the telecommunications network in this embodiment of this application may be approximately divided into two stages. Stage 1: Determine a valid alarm root cause rule set. Stage 2: A root cause alarm in an associated alarm combination is determined based on the valid alarm root cause rule set. The valid alarm root cause rule set herein is equivalent to the valid root cause rules selected from the candidate root cause rules in the foregoing description.

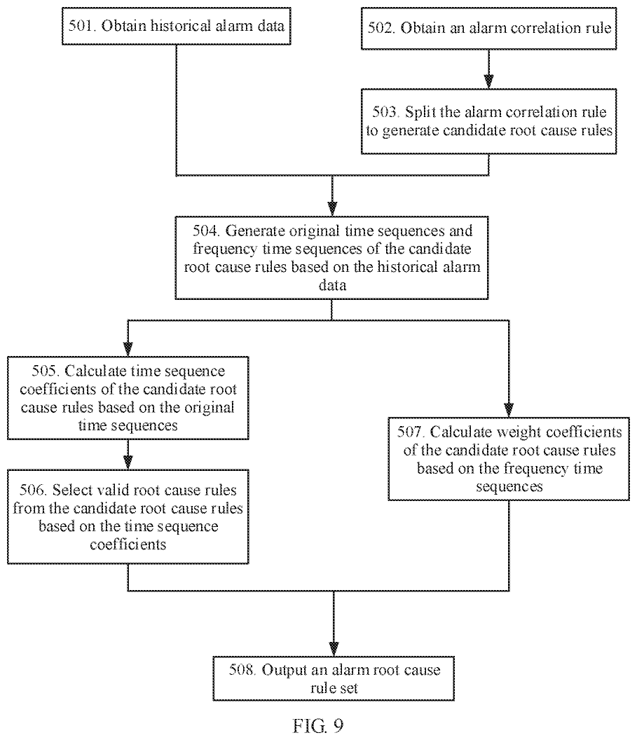

The following separately describes Stage 1 and Stage 2 of alarm location with reference to FIG. 9 to FIG. 14.

As shown in FIG. 9, determining the valid root cause rule set specifically includes step 501 to step 508, and specific processes in step 501 to step 508 may be performed by a server or a server cluster. The following separately describes step 501 to step 508 in detail.

Step 501: Obtain historical alarm data.

The historical alarm data may be alarm data collected from devices on the telecommunications network within a period of time. The historical alarm data may include a device on which an alarm occurs, an alarm occurrence time, an alarm category, and the like.

It should be understood that the historical alarm data may be directly collected by the server or the server cluster. Alternatively, the historical alarm data may be collected by a dedicated alarm collection platform. For example, the alarm data may be collected by an alarm collection cloud platform. The server or the server cluster obtains the historical alarm data from the alarm collection cloud platform.

Step 502: Obtain an alarm correlation rule.

The alarm correlation rule may be generated by frequently mining the historical alarm data. The alarm correlation rule may be obtained by frequently mining the historical alarm data, or by directly obtaining a preset alarm correlation rule. The preset alarm correlation rule may be previously obtained by frequently mining the historical alarm data. In addition, the preset alarm correlation rule is preset in the server or the server cluster (specifically, the alarm correlation rule may be pre-stored in the server).

Step 503: Split the alarm correlation rule to generate candidate root cause rules.

Generally, an association relationship or a causal relationship exists between alarms included in the alarm correlation rule. In other words, occurrence of an alarm in the alarm correlation rule may be accompanied with occurrence of another alarm. To obtain the association relationship or the causal relationship between different alarms in the alarm correlation rule, the alarm correlation rule may be first split into alarms in pairs to analyze an association relationship between every two alarms.

When the alarm correlation rule is split, a relatively common method is used to split an associated root cause rule, and alarms obtained by splitting are combined in pairs to obtain candidate root cause rules. It should be understood that there may be a plurality of candidate root cause rules herein, and each candidate root cause rule includes two alarms.

For example, an associated root cause rule ABC includes an alarm A, an alarm B, and an alarm C in total. The alarm correlation rule ABC indicates that there is an association relationship between the alarm A, the alarm B, and the alarm C. Six candidate root cause rules may be obtained by splitting the associated root cause rule ABC. The six candidate root cause rules are separately A−>B, A−>C, B−>A, B−>C, C−>A, and C−>B.

Step 504: Generate original time sequences and frequency time sequences of the candidate root cause rules based on the historical alarm data.

The original time sequences of the candidate root cause rules each are a time sequence constituted when alarms in the candidate root cause rules occur at a time interval. The frequency time sequences of the candidate root cause rules are a sequence including frequencies at which alarms in the candidate root cause rules occur at a time interval.

The following uses the candidate root cause rule A−>B as an example to describe in detail how to determine the original time sequences and the frequency time sequences of the candidate root cause rules.

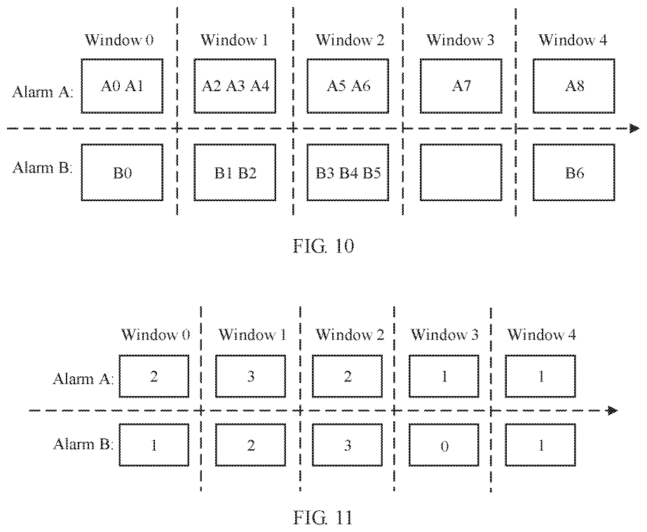

As shown in FIG. 10, all alarms A that occur on the telecommunications network in a period of time (for example, three months) are sorted in ascending order of timestamps to obtain a sequence of the alarm A. Then, the sequence of the alarm A is divided according to a specific time period (for example, five minutes) to obtain a plurality of time windows (only five windows are shown in FIG. 6 as an example). Only one of alarms A that occur on a same device in a same time window is reserved to obtain an original time sequence of the alarm A. An original time sequence of the alarm B can be obtained in a same way. As shown in FIG. 10, the original time sequences of the candidate root cause rule A−>B include the original time sequence of the alarm A and the original time sequence of the alarm B.

It should be understood that the original time sequences of the alarms in the candidate root cause rules indicate timestamps at which each alarm in the candidate root cause rules occurs in a period of time. Therefore, the time sequence information of the candidate root cause rules in the foregoing description may be obtained based on the original time sequence.

The frequency time sequences of the candidate root cause rules may be constructed based on the original time sequences of the candidate root cause rules.

The candidate root cause rule A−>B is still used as an example, Quantities of times that the alarm A and the alarm B occur in all windows may be separately collected based on the original time sequences of the alarms, and then the quantities of times that the alarm A and the alarm B occur in all the windows are filled into the windows to obtain the frequency time sequences of the candidate root cause rule

For example, a window 1 with an original time sequence of the candidate root cause rule A−>B includes alarms A2, A3, and A4 (alarms A2, A3, and A4 may be considered as the alarm A occurring on different devices). The window 1 with the original time sequence of the candidate root cause rule A−>B includes alarms B1 and B2 (alarms B1 and B2 may be considered as the alarm B occurring on different devices). In other words, the alarm A occurs three times in the window 1, and the alarm B occurs twice in the window 1. Next, the quantities of times that the alarm A and the alarm B occur in the window 1 is respectively filled to corresponding locations of the alarm A and the alarm B in the window 1. The frequency time sequences of the candidate root cause rule A−>B shown in FIG. 7 may be obtained by performing similar processing on another window in the foregoing manner. Finally, it is obtained that the frequency time sequence of the alarm A in the candidate root cause rule A−>B is 2 3 2 1 1, and the frequency time sequence of the alarm B in the candidate root cause rule A−>B is 1 2 3 0 1.

It should be understood that the frequency time sequence herein has a same meaning as the frequency sequence in the foregoing description, and both indicate a frequency or a quantity of times that an alarm in a candidate root cause rule occurs in a plurality of windows at a time interval.

Step 505: Calculate time sequence coefficients of the candidate root cause rules based on the original time sequences of the candidate root cause rules.

It should be understood that the time sequence coefficient in step 505 is a specific representation form of the time sequence information in the foregoing description.

The time sequence coefficients of the candidate root cause rules are used to reflect a probability that an alarm in each of the candidate root cause rules occurs before another alarm in terms of time, and are used to verify validity of causal relationships represented by the candidate root cause rules. For example, a time sequence coefficient of the candidate root cause rule A−>B reflects a probability that the alarm A occurs before the alarm B in terms of time, and is used to indicate validity of a causal relationship represented by the candidate root cause rule A−>B.

Specifically, the time sequence coefficient of the candidate root cause rule A−>B can reflect the validity of the causal relationship represented by the candidate A−>B. A larger time sequence coefficient indicates a higher probability that the alarm A occurs before the alarm B, indicating that occurrence of the alarm A is probably accompanied with occurrence of the alarm B. In other words, if the alarm A always occurs before the alarm B in most time windows, it can be deemed that the A−>B is true on a lame extent.

The original time sequences of the candidate root cause rules can reflect time at which different alarms in the candidate root cause rules occur. The time sequence coefficients of the candidate root cause rules reflect a probability that an alarm in each of the candidate root cause rules occurs before another alarm. The probability that an alarm in the candidate root cause rules occurs before another alarm can be calculated according to the time at which the different alarms in the candidate root cause rules occur. In other words, the time sequence coefficients of the candidate root cause rules can be calculated based on the original time sequences of the candidate root cause rules.

The time sequence coefficient of the candidate root cause rule A−>B is calculated in the following with reference to FIG. 10. Specifically, the time sequence coefficient of the candidate root cause rule A−>B may be calculated according to a formula (1).

$$T ( A , B ) = \frac{{\sum }_{i = 1}^{S} I ( \overline{{x}_{B i}} - \overline{{x}_{Ai}} )}{S} + α * prior\_t ( A , B ) \qquad ( 1 )$$

Herein, T(A,B) represents the time sequence coefficient of the candidate root cause rule A−>B. x̅_̅{̅A̅i̅}̅ and x̅_̅{̅B̅i̅}̅ respectively represent average time of original time sequences of the alarm A and the alarm B in a window i. S represents a quantity of time windows. A function I(x) is an indication function, and when x>0, I(x)=1, and x≥0, I(x)=0, prior_t(x,y) is a prior function, and indicates prior time sequence knowledge of the alarm x→y. prior_t(x y) may be generated based. on human experience α is a harmonic parameter. When α=0, the prior knowledge is not used to determine the time sequence coefficient.

Values that are of the time sequence coefficient T(A,B) and that are within different ranges may indicate that the candidate root cause rule A−>B has different validity.

A specific case of meaning indicated by the time sequence coefficient T(A,B) is as follows:

When T(A,B)>0.5, the candidate root cause rule A−>B is a valid root cause rule.

When 0<T(A,B)<0.5, the candidate root cause rule A−>B is an invalid root cause rule.

When T(A,B)=0.5, both the candidate root cause rule A−>B and the candidate root cause rule B−>A are valid root cause rules.

When T(A,B)=0, both the candidate root cause rule A−>B and the candidate root cause rule B−>A are invalid root cause rules.

It should be understood that, there may be another case for meaning of the time sequence coefficient T(A,B) in different value ranges. This is not limited in this application.

In an actual application scenario, due to impact of factors such as precision of alarm collection time, a statistical characteristic that the alarm A occurs before the alarm B in terms of time cannot be fully used as a sufficient condition for the A−>B. Therefore, in some special scenarios, validity of the A−>B needs to be determined with reference to experience of experts. For example, in each time window, an interval at which the alarm A and the alarm B actually occur is within milliseconds, but collection precision of an alarm collection device can only be accurate to second. Therefore, collection time (timestamps) of the alarm A and the alarm B may likely be the same, consequently, the validity of the A−>B cannot be determined based on an occurrence sequence of the alarm A and the alarm B. In this case, prior_t(A,B) is directly used as the time sequence coefficient (for example, 0.6) of the candidate root cause rule A−>B depending on the expert experience.

Step 506: Select valid root cause rules from the candidate root cause rules based on the time sequence coefficients.

Specifically, root cause rules whose time sequence coefficient is greater than a threshold may be selected in the candidate root cause rules as the valid root cause rules.

For example, a root cause rule whose time sequence coefficient is greater than or equal to 0.5 may be selected in the candidate root cause rules as the valid root cause rule.

It is assumed that the candidate root cause rules include A−>B, A−>C, B−>A, B−>C, C−>A, and C−>B. Sequence coefficients of the candidate rules A−>B, A−>C, B−>A, B−>C, C−>A, and C−>B are respectively (0.6), (0,7), (0.4), (0.5), (0.3), and (0.4). Therefore, the root cause rules A−>B, A−>C, and B−>C whose time sequence coefficients are greater than or equal to 0.5 may be selected from the candidate root cause rules as the valid root cause rules.

Step 507: Calculate weight coefficients of the candidate root cause rules based on the frequency time sequences.

The weight coefficients of the candidate root cause rules are used to indicate strength of causal relationships represented by the candidate root cause rules. For example, a weight coefficient of the candidate root cause rule A−>B is used to indicate strength of a causal relationship between the alarm A and the alarm B. A larger weight coefficient of the candidate root cause rule A−>B indicates greater strength of the causal relationship between the alarm A and the alarm B.

When the weight coefficients of the candidate root cause rules are calculated based on the frequency time sequence, the weight coefficients of the candidate root cause may be specifically determined based on similarities between frequency time sequences of alarms in the candidate root cause rules. A higher similarity between the frequency time sequences of the alarms in the candidate root cause rules indicates a larger weight coefficient of the candidate root cause rules.

The time sequence coefficient of the candidate root cause rule A−>B is calculated in the following with reference to FIG. 11. Specifically, the weight coefficient of the candidate root cause rule A−>B may be calculated according to a formula (2).

$$W ( A , B ) = \frac{{\sum }_{i = 1}^{S} {C}_{Ai} * {C}_{Bi}}{{\sum }_{i = 1}^{S} {C}_{Ai}^{2} * {\sum }_{i = 1}^{n} {C}_{Bi}^{2}} + α * prior\_w ( A , B ) \qquad ( 2 )$$

Herein, W(A,B) represents the weight coefficient of the candidate root cause rule A−>B. C_{Ai} and C_{Bi} respectively represent values of frequencies (frequency values) of frequency time sequences of the alarm A and the alarm B in a window S is a quantity of time windows, prior_t(x,y) is a prior function, and represents prior time sequence knowledge of alarm x→y. prior_t(x,y) may be generated based on human experience. α is a harmonic parameter. When α=0, the prior knowledge is not applicable for determining the weight coefficient.

The time sequence coefficients and the weight coefficients of the valid root cause rules may be obtained by performing the foregoing steps, so that a valid root cause rule in a triplet form may be obtained.

The valid root cause rule A−>B is used as an example, triplet information of the valid root cause rule A−>B shown in Table 1 may be obtained.

TABLE 1

| | | |
|---|---|---|
| Alarm A | Alarm B | Weight W |

As shown in Table 1, the alarm A is a first-order alarm, the alarm B is a post-order alarm, and a weight coefficient between the alarm A and the alarm B is W

Step 508: Output an alarm root cause rule set

Valid root cause rules are combined to obtain the alarm root cause rule set.

For example, valid root cause rules obtained after step 506 are A−>B, A−>C, and B−>C. Weight coefficients of A−>B, A−>C, and B−>C are respectively 0.8, 0.4, and 0.6. In this case, an alarm root cause rule set {(A−>B, 0.8), (A−>C, 0,4), (B−>C, 0.6)} may be obtained.

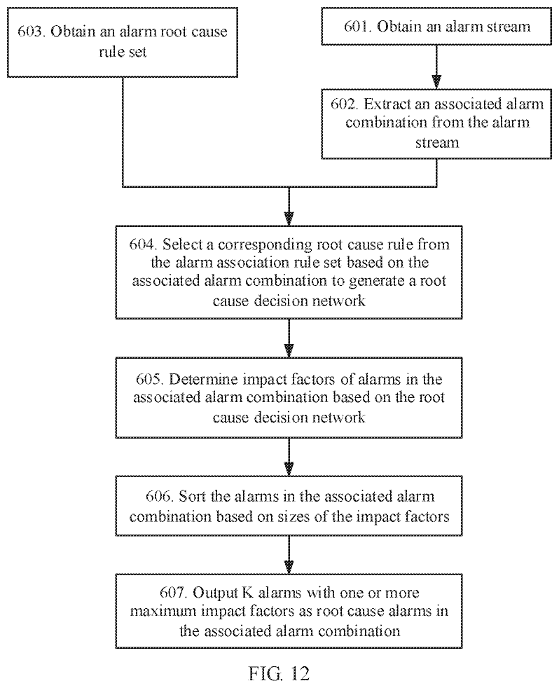

As shown in FIG. 12, determining the valid root cause rule set specifically includes step 601 to step 607. The following separately describes step 601 to step 607 in detail.

Step 601: Obtain an alarm stream.

Specifically, the alarm stream may be obtained from an alarm collection cloud platform.

Step 602: Extract an associated alarm combination from the alarm stream.

Specifically, an alarm compression technology may be used to combine alarms that are associated with a service alarm and that are in the alarm stream, to obtain the associated alarm combination.

Step 603: Obtain an alarm root cause rule set.

The alarm root cause rule set in step 603 may be obtained by performing step 501 to step 507.

Step 604: Select a corresponding root cause rule from the alarm root cause rule set based on the associated alarm combination to generate a root cause decision network.

When a corresponding root cause rule is selected from the alarm root cause rule set based on the associated alarm combination, the selected root cause rule has alarms that are in the associated alarm combination.

For example, if an associated alarm combination A₁A₂A₃A₄A₅A₆ is extracted. from the alarm stream, the following root cause rules may be selected from the root cause rule set:
(A₁−>A₂, d₁)
(A₁−>A₃, d₂)
(A₂−>A₁, d₃)
(A₃−>A₅, d₄); and
(A₅−>A₆, d₅)

Herein, d₁ to d₅ are respectively weight coefficients of these root cause rules.

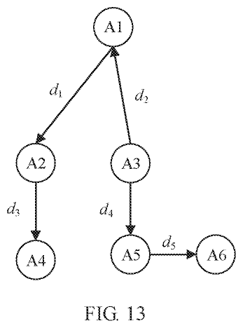

Next, the root cause decision network may be constructed based on the foregoing selected root cause rules. The constructed root cause decision network is shown in FIG. 13.

Step 605: Determine an impact factor of each alarm in the associated alarm combination based on the root cause decision network.

It should be understood that the impact factor herein is used to indicate an impact range of an alarm. The impact factor reflects a possibility (or referred to as a weight) that an alarm is a root cause alarm, so as to subsequently recommend or determine of the root cause alarm based on the impact factor. A greater impact factor indicates a higher possibility that the alarm is the root cause alarm.

Specifically, the impact factor of each alarm may be calculated according to a formula (3).

$$IF ( A ) = 1 + α * {\sum }_{B ∈ {N}_{out} ( A )} ( W ( A , B ) * IF ( B ) ) \qquad ( 3 )$$

Herein, IF(A) is an impact factor of the alarm A. Nₒᵤₜ(A) indicates a set of all subsequent alarms that take the A as the first-order alarm and that are on the root cause decision network α is a harmonic parameter, where 0<α≤1, and α may be set based on experience.

A root cause decision network shown in FIG. 13 is used as an example. Impact factors of the alarms in the associated alarm combination A₁A₂A₃A₄A₅A₆ may be obtained according to the formula (3). The impact factors are shown in formula (4) to formula (9):

IF(A₁)=1+d₁(1+d₃)+d₂(1+d₄(1+d₅0 (4)

IF(A₂)=1+d₃ (5)

IF(A₃)=1+d₄(1+d₅) (6)

IF(A₄)=0 (7)

IF(A₅)=1+d₅ (8); and

IF(A₆0=1+d₆ (9)

Step 606: Sort the alarms in the associated alarm combination based on values of the impact factors.

The impact factors of the alarms may be obtained by performing step 605. Subsequently, the alarms in the associated alarm combination may be sorted in descending order or ascending order of the impact factors.

Step 607: Output K alarms with one or more maximum impact factors as the root cause alarms in the associated alarm combination.

K alarms with one or more maximum impact factors may be selected from the alarms as the root cause alarms based on the sorting result in step 606. Herein, K may be an integer greater than or equal to 1, and the value of K may be set based on an actual requirement.

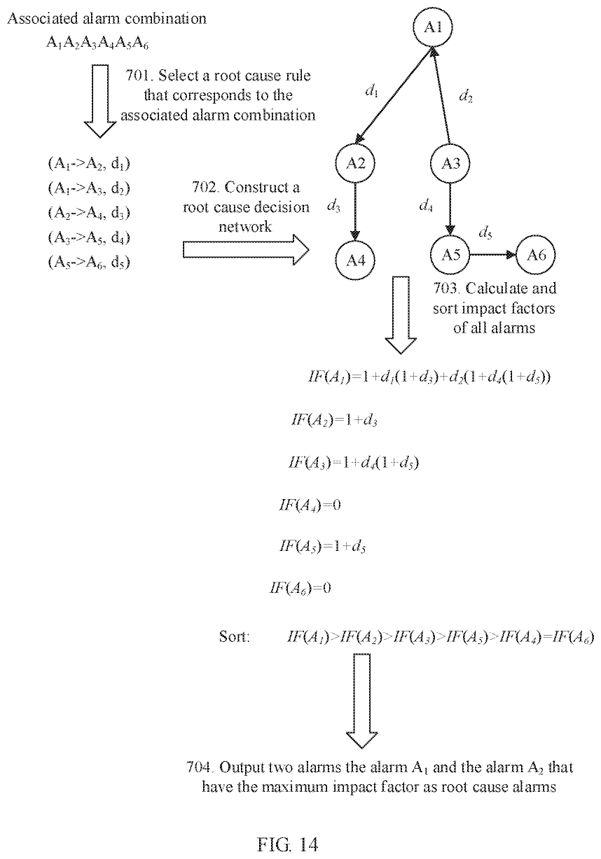

The following describes a specific process of determining the root cause alarm in the associated alarm combination A₁A₂A₃A₄A₅A₆ in detail with reference to FIG. 14.

The process of determining the root cause alarm shown in FIG. 14 mainly includes the following steps.

Step 701. Select a root cause rule that corresponds to the associated alarm combination.

A root cause rule that is in valid root cause rules and that includes any two alarms in the A₁A₂A₃A₄A₅A₆ is selected to obtain root cause rules corresponding to the A₁A₂A₃A₄A₅A₆. The obtained root cause rules are specifically as follows:
(A₁−>A₂, d₁)
(A₁−>A₃, d₂)
(A₂−>A₄, d₃)
(A₃−>A₅, d₄); and
(A₅−>A₆, d₅)

Herein, d₁ to d₅ are respectively weight coefficients of these root cause rules.

Step 702: Construct a root cause decision network.

The root cause rule network is constructed based on the root cause rules corresponding to the associated alarm combination A₁A₂A₃A₄A₅A₆. When the root cause decision network is constructed, alarms are specifically constructed as a network based on a sequence of the alarms in the root cause alarms, and are marked with corresponding weight coefficients.

Step 703: Calculate impact factors of all alarms and sort the alarms based on values of the impact factors.

The impact factors of all alarms in the associated alarm combination A₁A₂A₃A₄A₅A₆ are as follows:

IF(A₁)=1+d₁(1+d₃)+d₂(1+d₄(1+d₅)

IF(A₂)=1+d₃

IF(A₃)=1+d₄(1+d₅)

IF(A₄)=0

IF(A₅)=1+d₅; and

IF(A₆)=1+d₆

The alarms are sorted based on values of the impact factors to obtain the following results:

IF(A₁)>IF(A₂)>IF(A₃)>IF(A₅)>IF(A₄)=IF(A₆)

In other words, the alarm A₁ is an alarm that imposes the maximum impact factor in the associated alarm combination A₁A₂A₃A₄A₅A₆, and the alarm A4 and the alarm A6 are two alarms that have the minimum impact factor in the associated alarm combination A₁A₂A₃A₄A₅A₆. Subsequently, an alarm that meets a requirement may be selected, based on the requirement, from associated alarm combination A₁A₂A₃A₄A₅A₆ as a root cause alarm.

Step 704: Two alarms the alarm A₁ and the alarm A₂ that impose maximum impact factors are output as root cause alarms.

It should be understood that, in an actual application process, a quantity of root cause alarms selected from the associated alarm combination may be determined based on a requirement. The quantity of root cause alarms may be one or more.

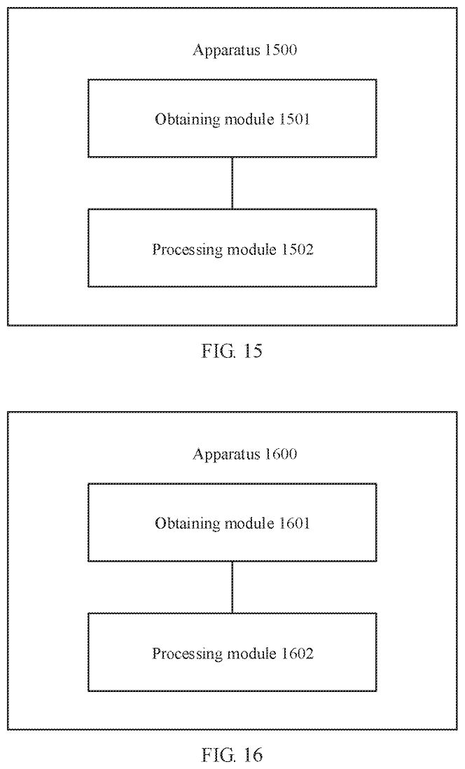

The foregoing specification describes in detail the method for locating the root cause alarm on the telecommunications network according to the embodiments of this application with reference to FIG. 1 to FIG. 14. The following describes in detail an apparatus for locating a root cause alarm on a telecommunications network according to an embodiment of this application with reference to FIG. 15 and FIG. 16. It should be understood that apparatuses in FIG. 15 and FIG. 16 can perform steps of the method for locating the root cause alarm on the telecommunications network according to the embodiments of this application. The apparatuses in FIG. 15 and FIG. 16 may be execution bodies of the method for locating the root cause alarm on the telecommunications network according to the embodiments of this application. For brevity, repeated descriptions are appropriately omitted when the following describes the apparatuses shown in FIG. 15 and FIG. 16.

FIG. 15 is a schematic block diagram of an apparatus for locating a root cause alarm on a telecommunications network according to an embodiment of this application, The apparatus 1500 shown in FIG. 15 includes an obtaining module 1501 and a processing module 1502.

The obtaining module 1501 is configured to obtain an alarm correlation rule of the telecommunications network.

The processing module 1502 is configured to split the alarm correlation rule to obtain candidate root cause rules; determine time sequence information of the candidate root cause rules based on historical alarm data of the telecommunications network, where the candidate root cause rules each include a first alarm and a second alarm, and the time sequence information of the candidate root cause rules is used to indicate a probability that the first alarm occurs before the second alarm in terms of time; determine valid root cause rules in the candidate root cause rules based on the time sequence information of the candidate root cause rules; extract an associated alarm combination from an alarm stream of the telecommunications network; and determine a root cause alarm in the associated alarm combination based on the valid root cause rules.

In this application, the valid root cause rules may be selected from the candidate root cause rules based on a probability that an alarm in each of the candidate root cause rules occurs before another alarm in terms of time (in other words, the valid root cause rules may be selected from the candidate root cause rules based on the time sequence information). Therefore, the root cause alarm can be more accurately located based on the valid root cause rules.

The apparatus 1500 may be specifically a server on the telecommunications network, or an apparatus or a module that is on a server and that is configured to locate the root cause alarm. The obtaining module 1501 and the processing module 1502 that are in the apparatus 1500 may be specifically units or modules that have a computing function and that are on the server, for example, may be a central processing unit.

FIG. 16 is a schematic block diagram of an apparatus for locating a root cause alarm on a telecommunications network according to an embodiment of this application. The apparatus 1600 shown in FIG. 16 includes an obtaining module 1601 and a processing module 1602.

The obtaining module 1601 is configured to obtain an alarm correlation rule of the telecommunications network.

The processing module 1602 is specifically configured to: split the alarm correlation rule to obtain candidate root cause rules; determine time sequence information of the candidate root cause rules based on historical alarm data of the telecommunications network, where the candidate root cause rules each include a first alarm and a second alarm, and the time sequence information of the candidate root cause rules is used to indicate a probability that the first alarm occurs before the second alarm in terms of time; determine weight information of the candidate root cause rules based on the historical alarm data, where the weight information of the candidate root cause rules is used to indicate strength of a causal relationship between the first alarm and the second alarm; determine valid root cause rules in the candidate root cause rules based on the time sequence information and the weight information of the candidate root cause rules; extract an associated alarm combination from an alarm stream of the telecommunications network; and determine a root cause alarm in the associated alarm combination based on the valid root cause rules.

In this application, valid root cause rules can be more accurately selected from the candidate root cause rules based on a probability that an alarm in each of the candidate root cause rules occurs before another alarm in terms of time and strength of a causal relationship between alarms in the candidate root cause rules. Therefore, the root cause alarm can be relatively accurately located based on the valid root cause rules.

The apparatus 1600 may be specifically a server on the telecommunications network, or an apparatus or a module that is on a server and that is configured to locate the root cause alarm. The obtaining module 1601 and the processing module 1602 that are in the apparatus 1600 may be specifically units or modules that have a computing function and that are on the server, for example, may be a central processing unit.

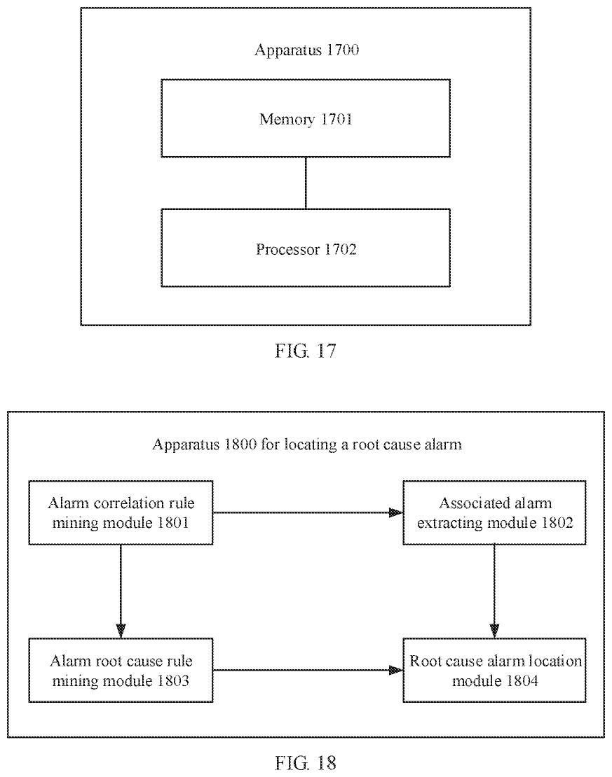

FIG. 17 is a schematic block diagram of an apparatus for locating a root cause alarm on a telecommunications network according to an embodiment of this application. The apparatus 1700 shown in FIG. 17 includes a memory 1701 and a processor 1702.

The memory 1701 is configured to store a program.

The processor 1702 is configured to execute the program stored in the memory 1701. When the program stored in the memory 1701 is executed, the processor 1702 is specifically configured to perform the method for locating the root cause alarm on the telecommunications network in this embodiment of this application. For example, the processor 1702 may be specifically configured to perform the steps performed by the processing module 1502 or the processing module 1602.

It should be understood that in the apparatus 1700, the memory 1701 may store an alarm correlation rule (specifically, may store the alarm correlation rule in a form of alarm correlation rule information) and historical alarm data that are of the telecommunications network. The processor 1702 may invoke the alarm correlation rule of the telecommunications network and the historical alarm data of the telecommunications network from the memory 1701.

The processor 1702 in the apparatus 1700 corresponds to the obtaining module 1501 and the processing module 1502 that are in the apparatus 1500 (the processor 1702 can implement functions of the obtaining module 1501 and the processing module 1502). The processor 1702 may further correspond to the obtaining module 1601 and the processing module 1602 that are in the apparatus 1600 (the processor 1702 can implement functions of the obtaining module 1601 and the processing module 1602).

The apparatus 1700 may be specifically a server on the telecommunications network, or an apparatus or a module that is on a server and that is configured to locate the root cause alarm. The memory 1701 in the apparatus 1700 may be specifically a storage unit or a storage module that is on the server. The processor 1702 may be specifically a unit or a module that has a computing function and that is on the server, for example, a central processing unit.

FIG. 18 is a schematic block diagram of an apparatus for locating a root cause alarm according to an embodiment of this application. The apparatus 1800 that is for locating the root cause alarm and that is shown in FIG. 18 specifically includes: an alarm correlation rule mining module 1801, an associated alarm extracting module 1802, an alarm root cause rule mining module 1803, and a root cause alarm location module 1804.

The apparatus 1800 for locating the root cause alarm can perform the method for locating the root cause alarm on the telecommunications network in this embodiment of this application. For example, the alarm correlation rule mining module 1801 can perform step 101 in the method shown in FIG. 1. The associated alarm extracting module 1802 can perform step 105 in the method shown in FIG. 1. The alarm root cause rule mining module 1803 can perform step 102 to step 104 that are in the method shown in FIG. 1. The root cause alarm location module 1804 can perform step 106 in the method shown in FIG. 1.

For another example, the alarm correlation rule mining module 1801 can perform step 201 in the method shown in FIG. 2. The associated alarm extracting module 1802 can perform step 205 in the method shown in FIG. 2. The alarm root cause rule mining module 1803 can perform step 202 to step 204 that are in the method shown in FIG. 2. The root cause alarm location module 1804 can perform step 206 in the method shown in FIG. 2.

The alarm correlation rule mining module 1801 in the apparatus 1800 for locating the root cause alarm may correspond to the obtaining module 1501 in the apparatus 1500 and the obtaining module 1601 in the apparatus 1600, and is configured to obtain an alarm correlation rule of the telecommunications network. The associated alarm extracting module 1802, the alarm root cause rule mining module 1803, and the root cause alarm location module 1804 correspond to the processing module 1502 in the apparatus 1500 and the processing module 1602 in the apparatus 1600, and are configured to determine a root cause alarm in an associated alarm combination.

All the modules in the apparatus 1800 for locating the root cause alarm correspond to the processor 1702 in the apparatus 1700, and are configured to complete an entire process from obtain the alarm correlation rule of the telecommunications network to determine the root cause alarm in the associated alarm combination.

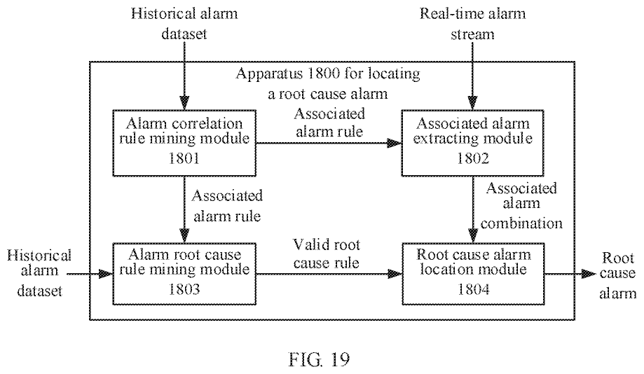

To better understand a working procedure of each module in the apparatus 1800 for locating the root cause alarm, the following briefly describes, with reference to FIG. 19, an entire process in which the root cause alarm is located by the apparatus 1800 for locating the root cause alarm.

FIG. 19 is a schematic diagram of locating a root cause alarm by an apparatus for locating the root cause alarm according to an embodiment of this application. The process of locating the root cause alarm shown in FIG. 19 mainly includes the following steps:

Step 1: The alarm correlation rule mining module 1801 mines a historical alarm dataset to obtain the alarm correlation rule.

Step 2: The associated alarm extracting module 1802 processes a real-time alarm stream based on the alarm correlation rule obtained by the alarm correlation rule mining module 1801, and extracts an associated alarm combination from the real-time alarm stream.

Step 3: The alarm root cause rule mining module 1803 filters, based on the historical alarm dataset, the alarm correlation rule obtained by the alarm correlation rule mining module 1801, to obtain valid root cause rules.

Step 4: The root cause alarm locating module 1804 performs root cause alarm locating on the associated alarm combination based on the valid root cause rules extracted by the alarm root cause rule mining module 1803 to determine the root cause alarm.

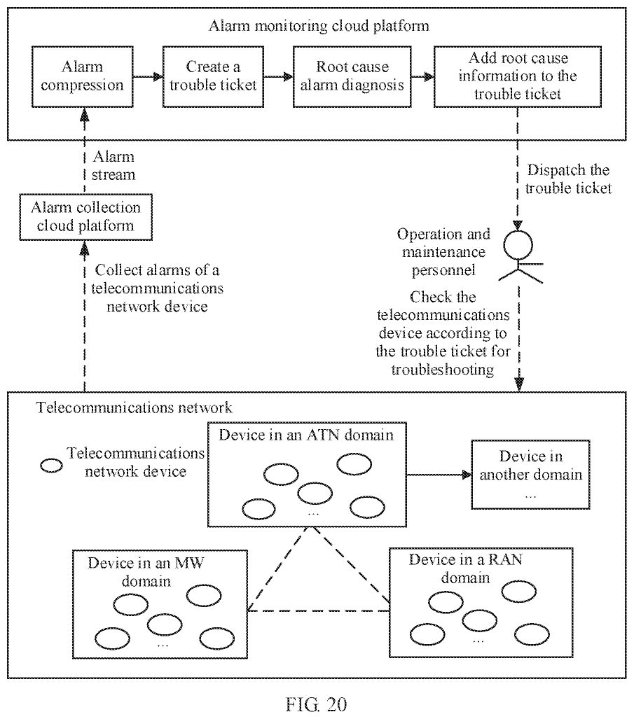

FIG. 20 is a schematic diagram of an application scenario according to an embodiment of this application.

The method for locating the root cause alarm on the telecommunications network in the embodiments of this application may be specifically applied to the application scenario shown in FIG. 20. The method for locating the root cause alarm in the embodiments of this application may be used to locate a root cause alarm of a telecommunications network device on the telecommunications network. Devices on the telecommunications network may specifically include a device in an ATN domain, a device in an MW domain, a device in a RAN domain, and a device in another domain.

As shown in FIG. 20, alarms generated on the telecommunications network may be collected by using an alarm collection cloud platform, and the alarms may be classified by domain based on an alarm reporting time and domain information to generate an alarm stream, and then the alarm stream is reported to an alarm monitoring cloud platform. After receiving the alarm stream, the alarm monitoring cloud platform first matches a corresponding alarm combination in the alarm stream according to an alarm compression rule of a single domain or a single network element, to create a trouble ticket. Then, a root cause alarm is located for an associated alarm combination in the trouble ticket according to the method for locating the root cause alarm on the telecommunications network in this embodiment of this application. Finally, a trouble ticket to which root cause alarm information is added is distributed to an operation and maintenance engineer. The engineer checks a corresponding telecommunications device based on information in the trouble ticket. The root cause alarm information is included in the trouble ticket. Therefore, once the root cause alarm is handled, other associated alarms are certainly cleared. Therefore, alarm efficiency and troubleshooting efficiency are greatly improved.

The method in the embodiments of this application may be performed in a process of root cause alarm diagnosis by the alarm monitoring cloud platform. Alternatively, the method for locating the root cause alarm on the telecommunications network may be performed in processes of alarm compression, creating a trouble ticket, and a root cause alarm diagnosis by the alarm monitoring cloud platform.

A person of ordinary skill in the art may be aware that units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that for the purpose of convenient and brief description, for a detailed working process of the described system, apparatus, and unit, refer to a corresponding process in the foregoing method embodiments.

In the several embodiments provided in this application, it should be understood that the disclosed system, apparatus, and method may be implemented in another manner. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in an electronic form, a mechanical form, or another form.

The units described as separate parts may or may not be physically separate, and parts displayed as units may or may not be physical units, and may be located in one location, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software function unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, or a network device) perform all or some of the steps of the methods described in the embodiments of this application. The storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for locating a root cause alarm on a telecommunications network, comprising:
obtaining an alarm correlation rule of the telecommunications network;
splitting the alarm correlation rule to obtain candidate root cause rules;
determining time sequence information of the candidate root cause rules based on historical alarm data of the telecommunications network, wherein the candidate root cause rules each comprise a first alarm and a second alarm, and wherein the time sequence information of the candidate root cause rules is used to indicate a probability that the first alarm occurs before the second alarm in terms of time;
determining valid root cause rules in the candidate root cause rules based on the time sequence information of the candidate root cause rules;
extracting an associated alarm combination from an alarm stream of the telecommunications network; and
determining a root cause alarm in the associated alarm combination based on the valid root cause rules.

2. The method according to claim 1, wherein the time sequence information is a time sequence coefficient, and wherein the determining valid root cause rules in the candidate root cause rules based on the time sequence information of the candidate root cause rules comprises:
determining, in the candidate root cause rules, root cause rules whose time sequence coefficients are within a preset range as the valid root cause rules.

3. The method according to claim 1, wherein the determining time sequence information of the candidate root cause rules based on historical alarm data of the telecommunications network comprises:
determining, based on the historical alarm data, a quantity of times that the first alarm occurs before or after the second alarm at a preset time interval; and
determining the time sequence information of the candidate root cause rules based on the quantity of times that the first alarm occurs before or after the second alarm at the preset time interval.

4. The method according to claim 1, wherein the determining a root cause alarm in the associated alarm combination based on the valid root cause rules comprises:
determining, in the valid root cause rules, a target root cause rule corresponding to the associated alarm combination, wherein alarms in the target root cause rule both exist in the associated alarm combination; and
determining the root cause alarm in the associated alarm combination based on the target root cause rule.

5. The method according to claim 4, wherein the determining the root cause alarm in the associated alarm combination based on the target root cause rule comprises:
determining weight information of the target root cause rule based on the historical alarm data, wherein the weight information of the target root cause rule is used to indicate strength of a causal relationship between alarms in the target root cause rule;
determining an impact factor of each alarm in the associated alarm combination based on the target root cause rule and the weight information of the target root cause rule, wherein the impact factor of each alarm is used to indicate a degree of impact of each alarm on another alarm in the associated alarm combination; and
determining the root cause alarm in the associated alarm combination based on the impact factor.

6. The method according to claim 5, wherein the determining the root cause alarm in the associated alarm combination based on the impact factor comprises:
determining K alarms in the associated alarm combination as the root cause alarms, wherein K is an integer greater than or equal to 1, and wherein impact factors of the K alarms each are greater than or equal to an impact factor of any other alarm in the associated alarm combination rather than the K alarms.

7. The method according to claim 6, wherein the determining weight information of the target root cause rule based on the historical alarm data comprises:
determining, based on the historical alarm data, frequencies at which a third alarm and a fourth alarm of the target root cause rule separately occur in a plurality of time windows at a preset time interval;
generating an occurrence frequency sequence of the third alarm based on the frequencies at which the third alarm separately occurs in the plurality of time windows at the preset time interval;
generating an occurrence frequency sequence of the fourth alarm based on the frequencies at which the fourth alarm separately occurs in the plurality of time windows at the preset time interval; and
determining the weight information of the target root cause rule based on a similarity between the occurrence frequency sequence of the third alarm and the occurrence frequency sequence of the fourth alarm.

8. An apparatus for locating a root cause alarm, comprising:
at least one processor; and
a non-transitory computer-readable storage medium coupled to the at least one processor and storing programming instructions for execution by the at least one processor, wherein the programming instructions instruct the at least one processor to perform the following operations:
obtaining an alarm correlation rule of a telecommunications network;
splitting the alarm correlation rule to obtain candidate root cause rules;
determining time sequence information of the candidate root cause rules based on historical alarm data of the telecommunications network, wherein the candidate root cause rules each comprise a first alarm and a second alarm, and wherein the time sequence information of the candidate root cause rules is used to indicate a probability that the first alarm occurs before the second alarm in terms of time;
determining valid root cause rules in the candidate root cause rules based on the time sequence information of the candidate root cause rules;
extracting an associated alarm combination from an alarm stream of the telecommunications network; and
determining a root cause alarm in the associated alarm combination based on the valid root cause rules.

9. The apparatus according to claim 8, wherein the time sequence information is a time sequence coefficient, and wherein the programming instructions instruct the at least one processor to perform the following operation:
determining, in the candidate root cause rules, root cause rules whose time sequence coefficients are within a preset range as the valid root cause rules.

10. The apparatus according to claim 8, wherein the programming instructions instruct the at least one processor to perform the following operations:
determining, based on the historical alarm data, a quantity of times that the first alarm occurs before or after the second alarm at a preset time interval; and
determining the time sequence information of the candidate root cause rules based on the quantity of times that the first alarm occurs before or after the second alarm at the preset time interval.

11. The apparatus according to claim 8, wherein the programming instructions instruct the at least one processor to perform the following operations:
determining, in the valid root cause rules, a target root cause rule corresponding to the associated alarm combination, wherein alarms in the target root cause rule both exist in the associated alarm combination; and
determining the root cause alarm in the associated alarm combination based on the target root cause rule.

12. The apparatus according to claim 11, wherein the programming instructions instruct the at least one processor to perform the following operations:
determining weight information of the target root cause rule based on the historical alarm data, wherein the weight information of the target root cause rule is used to indicate strength of a causal relationship between alarms in the target root cause rule;
determining an impact factor of each alarm in the associated alarm combination based on the target root cause rule and the weight information of the target root cause rule, wherein the impact factor of each alarm is used to indicate a degree of impact of each alarm on another alarm in the associated alarm combination; and
determining the root cause alarm in the associated alarm combination based on the impact factor.

13. The apparatus according to claim 12, wherein the programming instructions instruct the at least one processor to perform the following operations:
determining K alarms in the associated alarm combination as the root cause alarms, wherein K is an integer greater than or equal to 1, and wherein impact factors of the K alarms each are greater than or equal to an impact factor of any other alarm in the associated alarm combination rather than the K alarms.

14. The apparatus according to claim 12, wherein the programming instructions instruct the at least one processor to perform the following operations:
determining, based on the historical alarm data, frequencies at which a third alarm and a fourth alarm of the target root cause rule separately occur in a plurality of time windows at a preset time interval;
generating an occurrence frequency sequence of the third alarm based on the frequencies at which the third alarm separately occurs in the plurality of time windows at the preset time interval;
generating an occurrence frequency sequence of the fourth alarm based on the frequencies at which the fourth alarm separately occurs in the plurality of time windows at the preset time interval; and
determining the weight information of the target root cause rule based on a similarity between the occurrence frequency sequence of the third alarm and the occurrence frequency sequence of the fourth alarm.

15. A non-transitory computer-readable storage medium, comprising an instruction, wherein when the instruction is run on a computer, the computer is enabled to perform a method comprising:
obtaining an alarm correlation rule of a telecommunications network;
splitting the alarm correlation rule to obtain candidate root cause rules;
determining time sequence information of the candidate root cause rules based on historical alarm data of the telecommunications network, wherein the candidate root cause rules each comprise a first alarm and a second alarm, and wherein the time sequence information of the candidate root cause rules is used to indicate a probability that the first alarm occurs before the second alarm in terms of time;
determining valid root cause rules in the candidate root cause rules based on the time sequence information of the candidate root cause rules;
extracting an associated alarm combination from an alarm stream of the telecommunications network; and
determining a root cause alarm in the associated alarm combination based on the valid root cause rules.

16. The non-transitory computer-readable storage medium according to claim 15, wherein the time sequence information is a time sequence coefficient, and wherein the determining valid root cause rules in the candidate root cause rules based on the time sequence information of the candidate root cause rules comprises:
determining, in the candidate root cause rules, root cause rules whose time sequence coefficients are within a preset range as the valid root cause rules.

17. The non-transitory computer-readable storage medium according to claim 15, wherein the determining time sequence information of the candidate root cause rules based on historical alarm data of the telecommunications network comprises:
determining, based on the historical alarm data, a quantity of times that the first alarm occurs before or after the second alarm at a preset time interval; and
determining the time sequence information of the candidate root cause rules based on the quantity of times that the first alarm occurs before or after the second alarm at the preset time interval.

18. The non-transitory computer-readable storage medium according to claims 15, wherein the determining a root cause alarm in the associated alarm combination based on the valid root cause rules comprises:
determining, in the valid root cause rules, a target root cause rule corresponding to the associated alarm combination, wherein alarms in the target root cause rule both exist in the associated alarm combination; and
determining the root cause alarm in the associated alarm combination based on the target root cause rule.

19. The non-transitory computer-readable storage medium according to claim 18, wherein the determining the root cause alarm in the associated alarm combination based on the target root cause rule comprises:
determining weight information of the target root cause rule based on the historical alarm data, wherein the weight information of the target root cause rule is used to indicate strength of a causal relationship between alarms in the target root cause rule;
determining an impact factor of each alarm in the associated alarm combination based on the target root cause rule and the weight information of the target root cause rule, wherein the impact factor of each alarm is used to indicate a degree of impact of each alarm on another alarm in the associated alarm combination; and
determining the root cause alarm in the associated alarm combination based on the impact factor.

20. The non-transitory computer-readable storage medium according to claim 19, wherein the determining the root cause alarm in the associated alarm combination based on the impact factor comprises:
determining K alarms in the associated alarm combination as the root cause alarms, wherein K is an integer greater than or equal to 1, and wherein impact factors of the K alarms each are greater than or equal to an impact factor of any other alarm in the associated alarm combination rather than the K alarms.
